(19) United States
(12) Patent Application Publication
(10) Pub. No.: US 2003/0233310 A1
(43) Pub. Date: Dec. 18, 2003

(54) Method and system for implementing a business transaction over the internet with use and consecutive transformation of information from publicly available databases, actual preferences of potential customers and statistical models of the market situation

(76) Inventor: Boris Stavrovski, New York, NY (US)

Correspondence Address: Dr. Boris Stavrovski, 171 East 84 st Apt 17D, New York, NY, 10028, US

(21) Appl. No.: 10/172,064

(22) Filed: Jun. 17, 2002

(51) Int. Cl. G06F 17/60

(52) U.S. Cl. 705/37

(57) ABSTRACT

A method and a system for implementing a business transaction over the Internet that involves search, negotiations and legal closing with multiple participants (i.e., real estate business) in which the computerized system communicates with potential participants consecutively, creates mathematical approximations for their multidimensional utility and flexibility functions based on information voluntarily supplied by the participants, organizes the search of admissible items at preliminary defined search domains, generates the fair price evaluations for each item, which the participants are interested in, based on statistical models of the market situation, organizes the process of interactive negotiations between participants at preliminary defined negotiation domains with the use of fair price evaluations and Pareto analysis, delivers to the participants the possibilities to sign the contract electronically and to finish the total process with due diligence and legal closing online.

### BACKGROUND OF THE INVENTION

This invention relates to a method and a computerized system for implementing any type of business transaction, whereby-a customer can search for a product or a service, negotiate with the provider of the said product or of the said service, and proceed to the legal closing of the transaction over the Internet (i.e., real estate transaction). In particular, it relates to a method and a system for implementing a business transaction that involves search, negotiations and legal closing over the internet on the basis of se and consecutive transformation of information from publicly available databases, information about participant's actual preferences and the statistical models of the market situation.

The development of electronic commerce with its numerous publicly available databases is enlarging the types of products and services that could be found over the Internet from simple items that are easily described by several main features (i.e., books, airplane tickets, cars etc.) to more complicated, less standardized products (i.e., real estate, medical and legal services).

The complexity of successful electronic transaction for such cases originates from several sources, such as:

complexity of the product or of the service in question (i.e., real estate has a multidimensional description, which includes dozens of parameters—location, property type, price range, taxes, vintage, condition, construction type, lot and building size, number and types of rooms, parking type and size, type of-heating/cooling system, other facilities and amenities, type and condition of foundation, roof, floors, materials etc.);

complexity of the agreement to be negotiated by the participants in order to finalize the transaction (i.e., real estate lease contract contains such negotiable parameters as—commencement and expiration dates, term, basic and additional rent with payment schedule, operating expenses, taxes, free rent period, rental escalation, loss factor, parking space allocation, security deposit, late payment penalties, repairs and alterations, insurance, services and utilities, rights of first offer, option to renew or cancel, non-disturbance, estoppels certificate etc.);

complexity and interdependence of the customer's preferences (which cannot be described in a single measure i.e. money) above the possible multiple values for all parameters, describing the product and the agreement to be negotiated;

complexity of the search process, where the search domain and even the object to be found are not described in exact (quantitatively defined) terms, that causes the long and in some cases unsuccessful search process;

complexity of the negotiation process where each participant, having their own interests, preferences and emotions, may generate the negative result simply because they were not willing to persevere in finding the variant which would deliver the necessary compromise or were not willing to invite a reputable and neutral third party to recommend a solution;

complexity and cost of due diligence and legal closing processes.

There are several prior art approaches with attempts to help participants in eliminating or at least diminishing some of the problems connected with this process.

For instance, U.S. Pat. No. 5,664,115 is dedicated to the first step of the process (Product Search) and describes a system that matches buyers and sellers of real estate by using the Internet, where a host computer communicates with sellers and potential buyers. It then creates a set of records, each corresponding to a specific or particular item to be sold with respect to some selection criteria (price, size or location) provided by the potential buyer. However the problem of the choice in the multidimensional space of the item's parameters remains unsolved in that patent, leaving the buyer to choose the items from the listings, which have met preliminary sorting criteria. No specific limitations for the size of potential search domain are suggested either and this is making the potential time of search practically unlimited. The objective market analysis is not used to help with solution of the problem.

The method and apparatus described in U.S. Pat. No. 5,495,412 relates to the second step of the process (Negotiations) and describes the interactive computer-assisted negotiations with the use of utility functions for participants and with the use of Pareto optimality concept to filtrate the total space of possible decisions. However, neither the measurements of potential flexibility for the participants nor other objective information (i.e., about the market status) is used in that patent and that is the reason why no objective recommendations can be implemented on this basis after the effective border (Pareto curve) has already been generated, leaving participants with the task of obtaining their own compromise. Again no specific limitations for the size of potential negotiation domain have been suggested in that patent either, which makes the potential time of negotiation practically unlimited. A method and system for discovery of trades between parties, described in U.S. Patent application No. 20020016759, also relates to the step of negotiations in between buyer and seller and uses some approximation of the buyer's utility function to find a “win-win” solution for negotiation process. The seller here is considered to be just some kind of an online catalog with goods listed in it. The only market reality to be discussed here is the availability of several sellers for the same product or good.

It is in particular very essential that all three of the prior art approaches described above have ignored as the distinction between fixed parameters of the product and negotiable parameters of the contract so the interdependencies in customer's degree of satisfaction over these different spaces of parameters.

In fact all of the prior art approaches have simply ignored also such evident fact that there are always three participants at the transaction of such kind—buyer, seller and the market. The role of the last one is not less important than the role of the others. The Internet is exactly the place where market's influence may be and should be included in the list of most crucial problem's variables.

Finally, the method and apparatus described in U.S. Pat. No. 5,692,206 relates to the last step of the process (Closing) and describes the automatic generation of a legal document but contains no details about the steps and procedures necessary for due diligence and legal closing.

While facilitating electronic commerce transactions, these and other prior art methods and systems [see References below/above] suffer from many disadvantages and drawbacks.

In particular, neither of prior art approaches is capable of helping to offer a solution to complexity related problems. In addition they are using the Internet simply as another tool of connection between participants (i.e., phone or fax), directly transferring the way of implementing a business transaction in a traditional manner into the Internet and thus eliminating many new and innovative ways, which have become available only through the Internet.

Further, any one of the prior art documents, related to the business transaction in question, does not deal with it as with the whole integrated process—as it in fact is. Recurrent repetitions of the previous process steps as a result of unsatisfactory subsequent steps are one of the most characteristic and complex features of the process as a whole.

### BRIEF SUMMARY OF THE INVENTION

It is an object of this invention to overcome the aforementioned limitations of the prior art. It is another object of the invention to provide ready access over the Internet for implementing a business transaction that involves search, negotiations and legal closing over the Internet on the basis of use and consecutive transformation of information from publicly available databases, information about participant's actual preferences and the statistical models of the market situation.

In particular, it is an object of the invention to provide a method and a system for implementing a business transaction over the Internet, which involves search, negotiation and legal closing wherein, the system:

evaluates real preferences of the potential customer (buyer) and defines the admissible search domain;

searches all publicly available databases and generates a statistical model of the market situation and tendencies at the market domain relating to the customer's preferences;

evaluates real preferences of the sellers at the same market domain and defines the admissible negotiation domains;

organizes the process of negotiations, pertaining to the information received, and formulates suggestions that will constitute the basis of a compromise;

generates the necessary legal documents and organizes the processes of due diligence and legal closing.

These objects and others are achieved through a method and a system for implementing a business transaction over the Internet with use and consecutive transformation of information from publicly available databases, wherein the system:

interactively communicates with potential customers (buyers) and with the use of information provided by them generates their approximate multidimensional utility and flexibility functions in the total space of the item's parameters and in the total space of the negotiable contract parameters;

defines the admissible search domain on the basis of information received from said approximate multidimensional utility and flexibility functions;

communicates with all publicly available databases and creates the first list of items in accordance with the largest values for the customer's approximate multidimensional utility function in the total space of the item's parameters;

analyzes the asking and selling contract terms within close proximity to the items of the first list all over the publicly available databases and generates the statistic models of asking and selling contract terms for the items of the first list;

reevaluates the search domain and repeats the search procedure, if necessary;

reduces the first list by excluding all items that contradict the fair price criteria and informs the customer about marginal prices of changing the item's parameters and about possible offering price model for negotiations with sellers;

corrects if necessary the customer's utility function as a result of information received from the previous step and on the basis of the interactive communication with the customer creates the second reduced list of items to be negotiated with sellers;

communicates with the sellers of the second list of items and generates approximate multidimensional utility and flexibility functions in the total space of the negotiable contract parameters for each of them,

defines the admissible negotiation domains for each pair of customer-seller on the basis of information received from said approximate multidimensional utility and flexibility functions;

generates the Pareto boundary curve at the negotiable space for each pair of customer/seller and selects the points of that curve which can constitute the admissible compromise for them on the basis of different criteria;

generates the third list of the items for which the compromises between said buyer and any one of said sellers were agreed upon by both of them;

organizes due diligence and legal closing proceedings for the best from the buyer's point of view item from the third list by contacting publicly available databases of necessary agents (i.e., title companies, house inspectors, mortgage and insurance companies/brokers, accountants and attorneys);

achieves quotes from them for fulfilling their functions in conjunction with the real estate item in question;

chooses the best offer for each type of service and orders these services after obtaining buyer's approval for this step;

using the professional agents' services online if necessary and possible, schedules the real or virtual closing with all agents and representatives and supplies this meeting with all legal and financial documentation to be signed and/or transferred.

According to one aspect of the invention, the system creates the buyer's approximate marginal utility functions by asking the buyer questions about equally preferable variants of the item's parameters and of the contract parameters independently, then generating the global utility function in form of direct superposition of two independent marginal utility functions.

According to another aspect of the invention, the system creates the buyer's global utility function in the one step process by asking the buyer questions about equally preferable variants of item's parameters and of the contract parameters simultaneously.

According to still another aspect of invention, the system defines search domain Ωs in accordance with formulae:

Ωs={∀XεΩ, [X₀−Rb(X)]≦X≦[X₀+Rb(X)]},

X₀=Arg Max Ub(X), ∀XεΩ,

Arg φ(Z)≡Z,

Rb(X)=ΔUb/Fb(X)+Rs(X),

Fb(X)=dUb(X)/dX,

where

Ω=Ω₁∪Ω₂ stands for the space of definition for all item's and contract's parameters;

Rb(X) stands for admissible radius of the search domain along the axis X;

ΔUb stands for the admissible level of the utility loss for said buyer;

Rs(X) stands for an a-priori value of the similar admissible radius due to the potential seller's flexibility;

Fb(X) stands for said buyer's global flexibility function;

Ub(X) stands for said buyer's global utility function;

X=(X₁, X₂);

X₁ stands for the element of the space of the item's parameters Ω₁;

X₂ stands for the element of the negotiable contract parameters space Ω₂.

According to still another aspect of invention, the system creates the first list of admissible items by solving the problem of the unconstrained utility function maximization at the item space.

According to yet another aspect of the invention, the system preliminary achieves the buyer's budget affordability limitations and then creates the first list of admissible items by solving the problem of constrained utility function maximization at the item space under the buyer's budget limitations.

According to yet another aspect of the invention, the system creates statistical models of the market situation and tendencies by implementing the next steps:

analyzes asking and selling contract terms in small proximity near the items of said first list all over said publicly available databases;

generates the models of asking and selling contract terms for the items of the said first list in static or dynamic form;

generates the models of possible offering prices for negotiations with sellers in static or dynamic form

According to still another aspect of invention, the system describes the admissible market domain Ωm as follows

Ωm=∪{∀Y, X_{ad1}−ΔX≦Y≦X_{ad1}+ΔX, ∀X_{ad1}εΩ}

or

Ωm=∪{∀Y, Ub(X_{ad1})−ΔUb≦Ub(Y)≦Ub(X_{ad1})+ΔUb, ∀X_{ad1}εΩ},

where

Y stands for the admissible point of statistics;

X_{ad1} stands for the parameters of the item included at the first list;

ΔX stands for the admissible maximum distance from the item with parameter X, ∀XεΩ;

Ub(*) stands for the said buyer's global utility function;

ΔUb stands for the admissible maximum loss in the said buyer's global utility function.

According to another aspect of the invention, the system generates the hierarchy of fair price models from linear models for obtaining marginal prices of item's parameters tifl nonlinear models for fair price hypothesis checking.

According to another aspect of the invention, the system additionally redefines the admissible search domain Ωs in accordance with formulae:

Ωs=Ωs′∪{Ωsj″, jε(1,m)},

Ωs′={∀XεΩ, [X₀−Rb(X)]≦X≦[X₀+Rb(X)]},

X₀=Arg Max Ub(X), ∀XεΩ,

Arg φ(Z)≡Z,

Rb(X)=ΔUb/Fb(X),

Fb(X)=dUb(X)/dX,

Ωsj″={∀X₂ⱼεΩ₂j, Yaj(X₂ⱼ)−Ysj(X₂ⱼ)≧0, ∃ X₂ⱼεΩs′, jε(1,m)},

where

Ω=Ω₁∪Ω₂ stands for the space of definition for all item's and contract's parameters;

Rb(X) stands for admissible radius of the search domain along the axis X;

ΔUb stands for the admissible level of the utility loss for said buyer;

Fb(X) stands for said buyer's global flexibility function;

Ub(X) stands for said buyer's global utility function;

X=(X₁, X₂);

X₁ stands for the element of the space of the item's parameters 21;

X₂ stands for the element of the negotiable contract parameters space Ω₂;

Yaj(X₂ⱼ) stands for the asking values of the contract terms for the parameter X₂ⱼ for each seller #j, jε(1,m);

Ysj(X₂ⱼ) stands for the selling values of the contract terms for the parameter X₂ⱼ for each seller #j, jε(1,m).

According to another aspect of the invention, the system generates said models of possible offering prices Po(X) for negotiations defining the surface of offering prices for all items of negotiable space in accordance with formulae

Po(X)=2 \overline{P}s(X)−Pa(X)

or

Po(X)={Arg₁{2 Ub[\overline{P}s(X)]−Ub[Pa(X)]}+Arg₂{2 Us[\overline{P}s(X)]−Us[Pa(X)]}}/2

where

\overline{P}s(X) stands for the statistical evaluation for the selling price of the item X;

Pa(X) stands for the asking price of the item X;

Ub, Us stands for the buyer's and the seller's utility functions consecutively;

Arg₁, Arg₂ stands for the functions which are opposite to Ub, Us consecutively:

Arg₁{Ub(Z)}≡Z, Arg₂{Us(Z)}≡Z.

According to another aspect of the invention, the system defines the negotiation domain Ωnj for the each pair of buyer/seller #j, jε(1,m), in accordance with the formulae:

Ωnj=Ωnbj∩Ωnsj,

Ωnbj={∀X₂εΩ₂, [X_{bof}−Rnbj(X₂)]≦X₂≦[X_{boj}+Rnbj(X₂)]},

Ωnsj={∀X₂εΩ₂, [Xₐₒⱼ−Rnsj(X₂)]≦X₂≦[Xₐₒⱼ+Rnsj(X₂)]}, jε(1,m),

X_{boj}=Arg Max Ub(X), ∀XεΩ₂,

Xₐₒⱼ=Arg Max Us(X), ∀XεΩ₂,

Arg φ(Z)≡Z,

Rnbj(X₂)=ΔUbj/Fb(X₂), Fb(X₂)=dUb(X₂)/dX₂,

Rnsj(X₂)=ΔUsj/Fsj(X₂), Fsj(X₂)=dUsj(X₂)/dX₂,

where

Rnbj(X₂) stands for the admissible radius of the negotiation domain due to the buyer's flexibility;

Rnsj(X₂) stands for the admissible radius of the negotiation domain due to the potential seller's flexibility;

ΔUbj stands for the admissible level of the utility loss for said buyer;

Fb(X₂) stands for the global buyer's flexibility function;

Ub(X₂) stands for the global buyer's utility function;

ΔUsj stands for the admissible level of the utility loss for said seller;

Fsj(X₂) stands for the global seller's flexibility function;

Usj(X₂) stands for the global seller's utility function;

X₂ stands for the element of the space Ω₂ of negotiable contract parameters.

According to still another aspect of the invention, the system suggests as a basis for compromise the points of Pareto curve which minimizes the maximal possible loss in utility function for any of the participants.

According to still another aspect of the invention, the system suggests as a basis for compromise the unique point of said Pareto curve that is the result of the next optimization problem (the Nash equilibrium):

X₂ₒₚₜ=Arg Max {Ub(X₂ₚ)*Us(X₂ₚ)},

where

X₂ₒₚₜ stands for the compromise in the space of negotiable contract terms;

Ub(X₂ₚ) stands for the buyer's utility function value at the Pareto curve points Xzp;

Us(X₂ₚ) stands for the seller's utility function value at the same points.

According to another aspect of the invention, the system generates the dynamic (time dependent) utility functions and fair price models then recommends the strategy of market optimal timing for the buyer with respect to additional payments for time dependent options to be negotiated with the seller.

### BRIEF DESCRIPTION OF SEVERAL VIEWS OF THE DRAWING

The objects, features and advantages of the present invention will become more apparent from the following detailed description of a preferred embodiment thereof taken in conjunction with the accompanying drawings, in which:

FIG. 1 is a block diagram of a system according to the invention;

FIGS. 2A and 2B are two portions of a flow chart illustrating the method of the preferred embodiment;

FIGS. 3A-E illustrates five sequential steps of interactive elaboration of the individual's utility function U(X₁,X₂), where on the plane (X₁,X₂) of the object's parameters the object “i” with parameters (X₁ᵢ,X₂ᵢ) is shown first (FIG. 3A); then the recipient should choose the equally preferential object “j” with parameters (X₁ⱼ, X₂ⱼ) by simply positioning the point X₂ⱼ on the direct line X₁=X₁ⱼ (FIG. 3B); connecting two points (X₁ᵢ,X₂ᵢ) and (X₁ⱼ,X₂ⱼ) we already may have the line of indifference for linear function U(X₁,X₂), where U(X₁,X₂)=const. (FIG. 3C); in the case of nonlinear U(X₁,X₂) we should proceed the same way with the third point U(X₁ₖ, X₂ₖ)—thus obtaining the nonlinear curve of indifference (FIG. 3D); repeating the procedure several times we obtain the family of such curves shown on FIG. 3E;

FIGS. 4A-D illustrates the concept of the admissible search domain and its conjunction with the flexibility of the recipient; FIG. 4A is a graph of utility functions U1(X) and U2(X) for two different individuals with different values of the flexibility function (first derivative of the utility function)—the same utility level (i.e., U=2.1) for them defines very different sets of possible values for the argument X; FIG. 4B illustrates the consequence of the geometrical constructions, that is essential for the definition of R₁ and R₂—the radiuses of the search domain for the individuals with utility functions U1(X) and U2(X); FIG. 4C illustrates the process of the reevaluation of the search domain with consecutive changes of the admissible buyer's utility losses; finally FIG. 4D illustrates the interdependence of the buyer's and the seller's utility functions on the plane (Xᵢ, Xⱼ) at the process of the definition of the admissible search domain for that case;

FIG. 5A illustrates the definition of the market analysis domain (shaded area) with constant distances 40 and 41 of the proximity to each item along the axis Xᵢ, Xⱼ; FIG. 5B illustrates the similar definition for the case of the constant admissible loss in the buyer's utility function—5%, 10%, 15% etc.

FIG. 6 illustrates the set of admissible outcomes and the Pareto curve on the plane (Ub, Us).

### DETAILED DESCRIPTION OF THE INVENTION

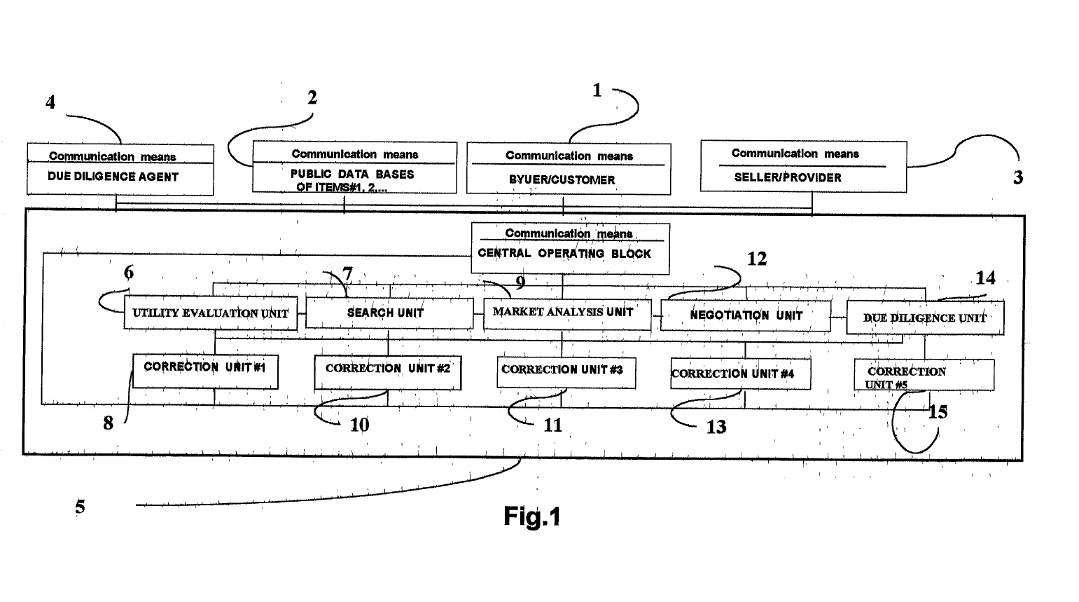

Tuning now to a detailed consideration of a preferred embodiment of the present invention, FIG. 1 illustrates a greatly simplified block diagram of the primary elements of the computer-based system which is employed for carrying out the method of the present invention.

The computer-based system includes a potential buyer's/customer's computer terminal 1 with its communication means (i.e., modem and phone line with possibilities to be connected with other parts of the system through the Internet), a plurality 2 of publicly available databases hosted over the Internet with its communication means, a plurality 3 of potential sellers'/providers' of services computer terminals with its communication means, a plurality 4 of due diligence agents' computer terminals with its communication means and finally a central operating block 5 with its communication means, whose activities are designated for combining the system to function as a whole creation rather than a simple collection of the independent elements.

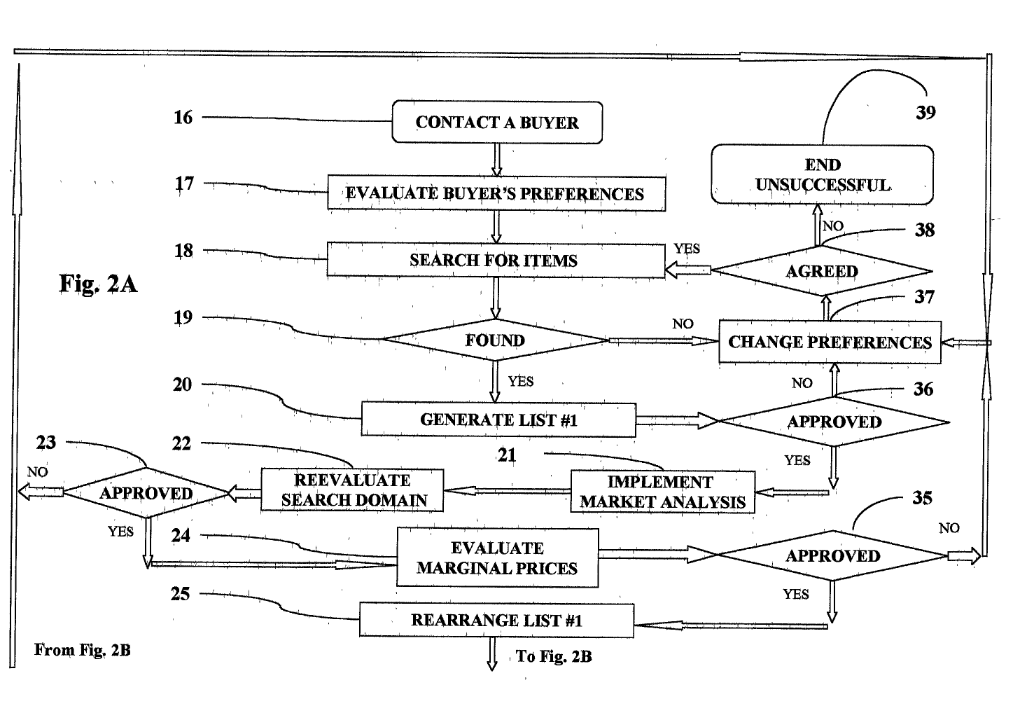

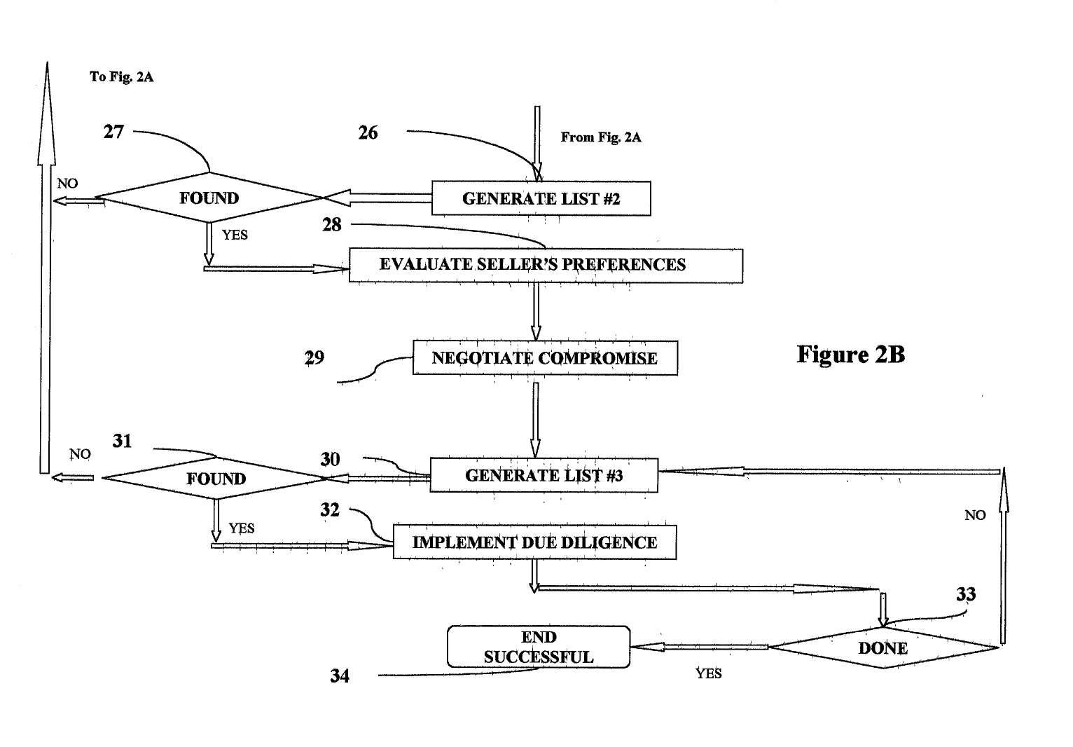

The mission of the whole system may be described as the consequence of steps illustrated on the simplified flowchart of the preferred embodiment in FIG. 2A and FIG. 2B:

after establishing the initial interactive contact with the potential buyers/customers 1 through the communication means over the Internet (position 16 at FIG. 2A) system analyzes their actual preferences in the space of the product's/service's parameters and in the space of contract's terms parameters thus defining the admissible domain for the consecutive search of product/service in question (being the part of the central operating block 5 as it is shown in FIG. 1 the utility evaluation unit 6 is programmed to calculate several quantitative characteristics of these preferences as described in detail below)—position 17 in FIG. 2A;

system contacts through the communication means over the Internet all publicly available databases 2, which may contain information about product/service in question, and organizes the search of admissible items inside of the search domain defined at the previous step (being the part of the central operating block 5 as it is shown in FIG. 1 the search unit 7 is programmed to search said databases as described in detail below and to generate the first list of admissible items in accordance with the buyer's preferences having been formulated on the previous step)—positions 18-20 in FIG. 2A;

in the case when said first list contains no items (no admissible items were found), system returns recurrently to the first step of the whole procedure with the suggestion to change buyer's preferences (to enlarge the search domain) or to cancel all procedure if the buyer disagrees with the suggested changes (being the part of the central operating block 5 as it is shown in FIG. 1 the first correction unit 8 is programmed to fulfill this step as described in detail below)—positions 19, 37-39 in FIG. 2A;

on the basis of information delivered from the publicly available databases 2 system creates the statistical models of the market situation and tendencies at the proximity of said first list of items including the models of the marginal market evaluations and the models of the prevailing (asking and selling) market contract terms (being the part of the central operating block 5 as it is shown in FIG. 1 the market analysis unit 9 is programmed to fulfill this step as described in detail below)—positions 21-24, 36 in FIG. 2A;

system reevaluates the admissible search domain and, if the changes are necessary, returns to the step of the search (being the part of the central operating block 5 as it is shown in FIG. 1 the market analysis unit 9 is programmed to fill this step as described in detail below)—positions 22-23 in FIG. 2A;

system contacts the potential buyer 1 again, informs about the marginal prices of the items' parameters from said first list and about marginal prices of the contract parameters for the same items, returns recurrently to the first step of the whole procedure, if the buyer considers to change preferences, or confirms the already existing first list of items, if the buyer considers not to change preferences (being the part of the central operating block 5 as it is shown in FIG. 1 the second correction unit 10 is programmed to fulfill this step as described in detail below)—positions 35, 37-39 in FIG. 2A;

system eliminates items from said first list, which are situated in contradiction with the statistical models of the market situation and tendencies (fair price hypothesis), as described in detail below, thus generating the second shorter list of negotiable items (for the implementation of this step the aforementioned market analysis unit 9 is responsible)—positions 25-26 in FIGS. 2A, 2B;

in the case when said second list contains no items, system returns recurrently to the first step of the whole procedure with the suggestion to change buyer's preferences (to enlarge the search domain) or cancels the procedure, if the buyer disagrees with the suggested changes (being the part of the central operating block 5 as it is shown in FIG. 1 the third correction unit 11 is programmed to fulfill this step)—positions 27, 37-39 in FIG. 2A;

after establishing the initial interactive contact with the potential sellers/providers 3 of the items from said second list through the communication means over the Internet, system evaluates their actual preferences in the space of negotiable contract's parameters and defines the negotiation domains as described in detail below (for fulfillment of this step the aforementioned utility evaluation unit 6 is responsible)—position 28 in FIG. 2B;

system organizes the processes of simultaneous interactive negotiations at said negotiation domains between buyer 1 and each of said sellers 3 and formulates suggestions which can constitute the basis of a compromises for the each pair buyer/seller as described in detail below (being the part of the central operating block 5 as it is shown in FIG. 1 the negotiation unit 12 is programmed to fulfil this step)—position 29 in FIG. 2B;

system generates the third list of the items, for which the compromises between the buyer 1 and any one of the sellers 3 were agreed upon by both of them and designates the final item from said third list, for which the result of the negotiation is best for the buyer, obtains the buyer's approval for finalizing the transaction after that as described in detail below (for fulfillment of this step the aforementioned negotiation unit 12 is responsible)—position 30 in FIG. 2B;

in the case when said third list contains no items, system returns recurrently to the first step of the whole procedure with the suggestion to change buyer's preferences (to enlarge the search domain) or cancels the procedure, if the buyer disagrees with the suggested changes (being the part of the central operating block 5 as it is shown in FIG. 1 the fourth correction unit 13 is programmed to fulfill this step)—positions 31, 37-39 in FIGS. 2A, 2B;

system generates all necessary legal documents and organizes the processes of due diligence and legal closing thus successfully finishing the procedure (being the part of the central operating block 5 as it is shown in FIG. 1 the due diligence unit 14 is programmed to fulfill this step)—positions 32-34 in FIG. 2B;

system returns recurrently to the next item from said third list if the due diligence process had been finished unsuccessfully (being the part of the central operating block 5 as it is shown in FIG. 1 the fifth correction unit 15 is programmed to fulfill this step)—position 33 in FIG. 2B;

in the case when said third list contains no more items, system returns recurrently to the first step of the whole procedure with the suggestion to change buyer's preferences (to enlarge the search domain) or cancels the procedure, if the buyer disagrees with the suggested changes (for fulfillment of this step the aforementioned fifth correction unit 15 is responsible)—position 31, 37-39 in FIGS. 2A, 2B.

Having in mind the whole described process it is now possible to define the details and the variants of the procedure for the each specific step.

The theory and formal apparatus of quantitative evaluation of preferences for an individual is the subject of so called utility theory. The main theoretical concepts of the utility theory have been described, for example, by Peter C. Fishburn in “nonlinear Preference and Utility Theory”, The Johns Hopkins University Press, Baltimore, 1988, 259 pp., the disclosure of which is incorporated herein by reference.

The main formal tool of the theory—the utility function—mathematically describes the individual's preferences within the total scope of possible ways of resolution and of predictable results for problem in question. The utility theory has good, established, practical and reliable algorithms (simple in 1-2 dimensional case but facing growing problems in multidimensional one—in fact all more or less complicated methods of mathematical logical analysis has such problems) for generating utility functions' approximations with predetermined exactness of description for the individual's preferences.

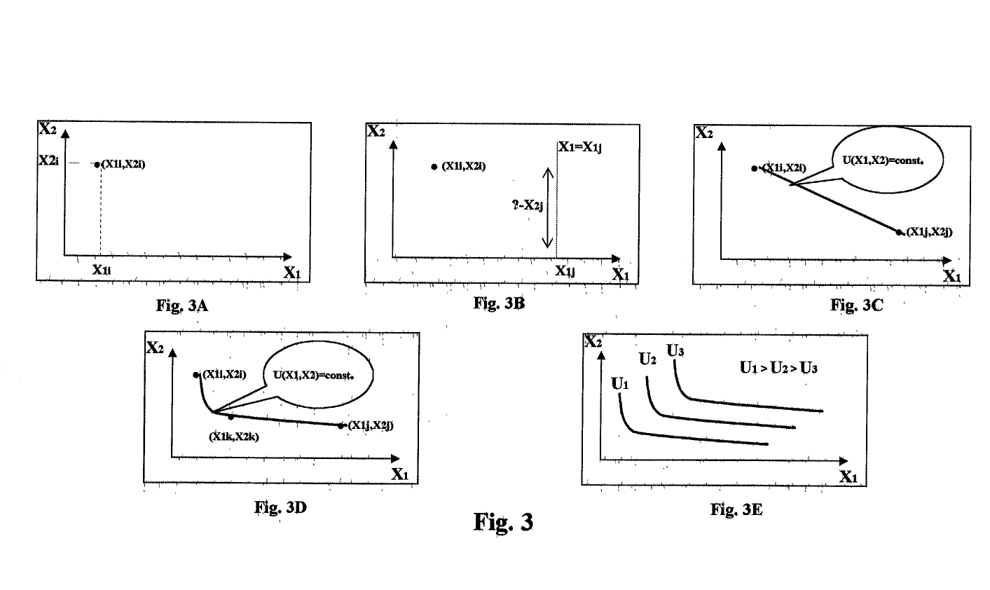

The idea of a such practical algorithm is fairly simple and may be illustrated with the sequence of drawings in FIG. 3, where on plane (X₁,X₂) of the problem's description parameters each particular point (X₁ᵢ,X₂ᵢ) represents the particular result “i” of the problem resolution—FIG. 3A.

The interactive procedure of the utility function elaboration starts with the next question to the recipient: “If in comparison with the result (X₁ᵢ,X₂ᵢ) you should choose the other result “j” with one already fixed component X₁ⱼ (let's say to be definite that X₁ⱼ>X₁ᵢ)—how will you pick the second component X₂ⱼ to achieve the result, which will be practically equal for you in its utility?” Geometrically (FIG. 3B) the recipient should place the point on the vertical line X₁=X₁ⱼ thus designating the second coordinate 2₂ⱼ of the point (X₁ⱼ,X₂ⱼ) with the same utility as the point (X₁ᵢ,X₂ᵢ) has for him.

When we are discussing the simplest case of linear indifference curve (the curve of indifference is connecting the results of equal utility for the recipient) we will obtain the only available variant of such curve in the form of a straight line connecting two points (X₁ᵢ, X₂ᵢ) and (X₁ⱼ, X₂ⱼ)—FIG. 3C.

The hypothesis of linearity for indifference curve can be checked by asking the recipient to find the third point (X₁ₖ, X₂ₖ) which will be equivalent in its utility for any of the two points defined previously. If the point ‘k’ will be found on the same straight indifference curve—the hypothesis is correct, adversely we should switch to nonlinear approximations of the indifference curve—this last case is illustrated in FIG. 3D.

As a result of such procedure we only have an approximation of the utility function, because any mathematical method used for its allocation can not guarantee that all other equivalent points will be exactly situated on the same indifference curve. However, in this case it is always possible to exactly evaluate the potential errors of that approximation. When we are not satisfied with these potential errors the number of equivalent points in consideration should be simply enlarged thus making the quality of approximation better. Finally, we will be able to receive the approximation of the recipient's utility function in the compact form

U(X₁, X₂) (1)

with possibilities to determine its computational errors in each point and with the family of constant level curves (the indifference curves) shown in FIG. 3E.

The same step by step logic of comparison for pairs of the results should be used in multidimensional case. This procedure becomes even easier under a broadly used assumption that the utility function of a psychologically normal individual can be approximated with so called logistic curve

U(X)=a+b*exp{−c*X}, (2)

where

a, b, c—stands for the constant coefficients;

X—stands for the scalar result of the problem's resolution.

In the case when the recipient's preferences can be described independently from each other, the global utility function in multidimensional space will constitute the simple superposition of the scalar (marginal) functions and its formal description will be the result of multiplication of these marginal functions:

U(X₁, X₂, . . . , Xₙ)=U(X₁)*U(X₂)* . . . *U(Xₙ). (3)

Again, the validity of this assumption can be easily checked on the basis of additional questioning of the recipient.

In the context of this invention we will pay special attention to the specifics of the two very different spaces of definition for relevant transaction parameters. The first is the space Ω₁ of the product's parameters, the elements of which X₁ are constant for any chosen item and can not become the subject of negotiation but are the variables for the search procedure. The second is the space Ω₂ of negotiable contract parameters, the elements of which X₂ should become constant as a result of a compromise between buyer (customer) and seller (provider of services) after the contract has been signed by them. The elements of this space are the variables for both the search and the negotiation procedures.

For exactness we will name the utility function U(X₁, X₂) the global one, and functions U(X₁), U(X₂)—the marginal ones.

Geometrically the spaces Ω₁ and Ω₂ are also very different. The space Ω₁ consists of the some limited number of the actual points X₁ⱼ, jε(0,n),—that stands for actual items—and of the unlimited number of the imaginary points X₁ᵢ, that could exist in principle in a real life, but never were found as a result of any search procedures at the publicly available databases. The number “n” is by itself the a-priori unknown function of the size for the space Ω₁. The example of such imaginary point is the so-called “ideal” item

X₀₁=Arg Max Ub(X₁), ∀X₁εΩ₁,

where Arg φ(Z) stands for the function which is opposite to (defines the argument of) φ(Z):

Z=Arg φ(Z).

The ideal point may or (more probably) may not exist but conceptually and algorithmically is very useful. We will use this ideal point as a starting (central) point of a search procedure and as a tool for an estimate for potential maximal level of the buyer's utility function Ub(X₁) as well.

The space Ω₂ consists of the unlimited number of the points X₂, and all of them are imaginary ones until the actual contract about one of the items X₁ⱼ, j ε(0, n), will be signed—at that moment the consequent point X₂ⱼ, j ε(0,n), also is becoming the actual one.

The third specific component of the problem to be considered is the actual time T with its limited interval of definition (Tₒ, Tₖ) between starting Tₒ and finishing Tₖ points of the time horizon in question. On comparatively short time intervals (i.e., months) we are not obliged to describe the time dependent behavior of the parameters

X₁=X₁(T), X₂=X₂(T) (4)

and of the spaces

Ω₁=Ω₁(T), Ω₂=Ω₂(T) (5)

as the variables on the interval (Tₒ, Tₖ), but dealing with longer intervals (i.e., years or decades) it will be necessary to do it.

This will further complicate the problem in its mathematical aspect (each of the functions (1)-(3) is becoming the function of T and all analytical and optimization procedures are much more resource intensive), but simultaneously will deliver new possibilities for decision making—as market timing for the buyer and the possibility to negotiate with the seller special additional payments (or discounts) in connection with time dependent arrangements and options. One of the main principles of the decision making theory (it is better to have more strategic possibilities than not to) confirms at least the necessity not to overlook these possibilities. So in some cases so called static models (1)-(3) will be good enough because we are not interested in the analysis of time dependent features, but in other cases the dynamic specifics (4)-(5) should be involved in the consideration.

Starting the procedure of generation of the global utility function in the space Ω=Ω₁∪Ω₂, it is necessary to articulate the difference between the general case (1) and the much less complicated case (3). In this second case the generation of the global utility function U(X₁, X₂) should be started by asking questions (see FIG. 3) about equally preferable variants of parameters at the item space Ω₁ and in the contract space Ω₂ independently, then generating approximate marginal utility functions U(X₁) and U(X₂) and calculating the global utility function as the direct superposition of the two independent marginal utility functions

U(X₁, X₂)=U(X₁)*U(X₂). (6)

Being the same in principle, the procedure of the generation of the global utility function U(X₁, X₂) in the first common case comprises of asking questions about equally preferable variants of parameters at the item space Ω₁ and in the contract space Ω₂ simultaneously—that means the larger dimension of the space of definition and consequently the larger efforts necessary to obtain the result.

Mathematically the utility function generates the metrics over the discrete sets of the item's and of the contract's parameters thus creating the continuous and compact spaces with the same names and simultaneously delivering the possibility to use the all well established algorithmic apparatus of analysis, search and optimization specially constructed for that kind of the spaces.

The main practical goal of obtaining the utility functions for the participants is to obtain the “right” criteria for the search and negotiation procedures to follow, instead of the usually used universal measures as the price or the other money equivalents. In our case the price is only one of the space Ω₂ components and that is up to the actual participants of the transaction to consider—rather it is the particular component that is the most essential. Different buyers may decide this dilemma in very different ways,

For example, there are two main types of buyers in typical real estate transactions. The first of them is buying the item as a place of residence and is mostly concerned with its consummation qualities. The second one considers the item as an investment opportunity and mostly concerns with its speculation potential, possible capital gains, rental income etc. The search and negotiation criteria for these two types of the buyers should not have very much in common.

In particular, it is very essential for the last type of the buyer to use the dynamic utility models (4)-(5), because the time dependent specifics of the transaction become crucial for its efficiency and profitability.

The utility function not only define the binary relation of preference in the space of the feasible alternatives (which delivers us the possibility to conclude that the result “i” is more preferable than the result “j”) but implicate the quantitative measure of this preference, thus making it possible to obtain the number that characterizes its comparable degree. Moreover we can evaluate how small variances of the argument will change the value of the utility function. This last quality gives us an unprecedented possibility to measure the personal readiness for a compromise in negotiations.

It is known from the differential calculus that the measure of function's response on small variations in its argument is its first derivative. From our point of view, after these considerations have been mentioned, it is logical enough to name “flexibility” the function

F(X)=dU(X)/dX (7)

and to use this function for additional calculations in two related topics:

as a measure of the personal readiness for changes in a scale of attractiveness for admissible items (search step of the procedure)—radius of the search domain;

as a measure of the personal readiness for concession (negotiation step of the procedure)—radius of the negotiation domain.

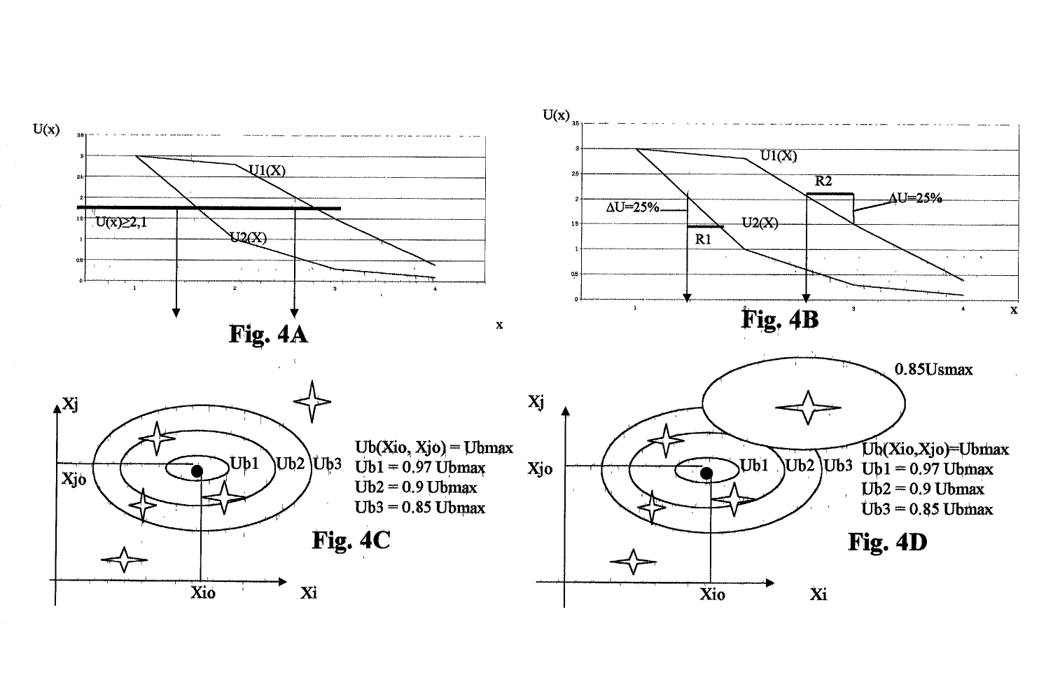

To explain the idea of such usage, in FIG. 4A two different variants of the typical utility curve U₁(X) and U₂(X) are shown. We can definitely conclude that the person with the utility function U₁(X) is much more flexible and prepared for compromise than the person with the utility function U₂(X). For example,

U₁(X)≧2.1, ∀Xε(0,1.5)

and

U₂(X)≧2.1, ∀Xε(0, 2.6).

Therefore, if both persons are going to find the items that are admissible in the sense of the limitation

U(X)≧2.1,

the size (the radius) of the search domain will be 1.5 units for the first person and 2.6 units for the second one. The same logic is valid for the discussion of the negotiation domain's sizes.

To obtain the simple mathematical formula for the radius of search domain it is necessary to look in FIG. 4B, where the procedure of the geometrical reconstruction of such radiuses R₁ and R₂ for two persons with the utility functions U₁(X) and U₂(X) respectively, are shown for the case when both of these persons have agreed upon the admissible level of the utility loss ΔU=25%. Evidently,

R(X)=ΔU/F(X),

F(X)=dU(X)/dX. (8)

Formula (8) is correct for defining the radius of the search domain in the case when only one person's (the buyer's) utility function is taken into consideration. For example, from FIG. 4C, where the lines of indifference for the buyer—in the form of ellipses for a bi-dimensional case (Xi, Xj))—are shown, and the admissible items are designated by the stars, it is clear that any admissible item is situated at the point of the maximal utility (ideal item does not exist), even a 3% loss of the utility does not generate any admissible variants, but a 15% loss of utility gives us three admissible items to be considered. It is evident that here, as everywhere else in this patent all formulae are valid in their vector (i.e., component by component) form.

If we will include in the consideration the potential seller's flexibility, we should enlarge the radius of the search domain as it is illustrated in FIG. 4D. Here the potential loss of 15% in the seller's utility function has been found admissible and as a result a fourth star (the fourth admissible item) has been added to the list. In this case, with the goal not to loose any admissible items, we should define the radius of the search domain with the formula:

Rb(X)=ΔUb/Fb(X)+Rs(X), (9)

where

Rb(X) stands for the buyer's admissible radius of the search domain along the axis X;

ΔUb stands for the admissible level of the utility loss for the buyer;

Rs(X) stands for an a-priori value of the similar admissible radius due to the potential seller's flexibility.

The ways of the a-priori Rs(X) definition, when its a-posteriori value is unknown, will be described further in the section devoted to the market analysis.

Geometrically the surface described by the formula (9) may be treated as a hyper-sphere, with radius Rb(X), and that circumstance gives us the possibility to name the distance Rb(X)—the radius of the search domain. The central point of this hyper-sphere is situated at the point with coordinates

X₀=Arg Max Ub(X), ∀XεΩ. (10)

Combining (9) and (10), we can now define the search space Ωs as follows

Ωs={∀XεΩ, [X₀−Rb(X)]≦X≦[X₀+Rb(X^{)]}.} (11)

Using some algorithmic considerations (i.e., simplicity of the search procedure), we may also embed this hyper-sphere into the hypercube with the size of the one dimension 2Rb(X) along the axis X.

After the buyer's utility function Ub(X) and the subspace of the potential search

Ωs [symbol] Ω (12)

have been determined, the search procedure can be defined as an unconstrained maximization of said utility function in the spaces of the item and contract parameters:

X_{ad1}=Arg Max Ub(X), ∀XεΩs [symbol] Ω. (13)

where X_{ad1} stands for the parameters of the item entitled to be admissible in the first list of the search results.

Evidently, in the case when the procedure (13) has been unsuccessfully finished and the first list contains no items, it is necessary to suggest to the buyer some changes in preferences (possible losses ΔUb) and then the problem (13) will acquire the next form

X_{ad1}=Arg {Ub(X)≧[Max Ub(X)−ΔUb]}, ∀XεΩs [symbol] Ω. (14)

The problem (14) for sure will have at least one nontrivial solution in case when ΔUb is sufficient and that is a very essential distinction from (13). It is necessary to mention that the size of the search domain Ωs(X) becomes simultaneously and automatically larger as a result of (9). If the buyer disagrees with the suggested changes in the preferences the whole procedure should be cancelled as an unsuccessful one.

Traditionally, similar systems are paying too much attention to the buyer's budget limitations, automatically excluding all variants which are not affordable to the buyer. Our experience shows that this position is not always correct.

First—after the serious negotiation the seller can often agree to concessions that will resolve the problem; and second—other features of the transaction (besides the price) can be extremely preferential for the buyer so that the additional money will be found—as a result of more creative financing. Nevertheless, when such budget limitations, for example,

B(X)≦Ba, (15)

(where Ba stands for the available funds) are known from the preliminary contacts with the buyer, the problems (13)-(14) can be easily transformed in the problem of maximization of the constrained utility function in the spaces of the item and contract parameters under said buyer's budget affordability limitations:

X_{ad1}=Arg Max Ub(X), ∀XεΩs [symbol] Ω. B(X)≦Ba, (13′)

X_{ad1}=Arg {Ub(X)≧[Max Ub(X)−ΔUb]}, ∀XεΩs [symbol] Ω. B(X)≦Ba. (14′)

From the point of view of the utility theory the buyer's budget limitations are already included in utility function Ub(X) and should not be treated in the form (13′)-(14′).

In principle the specifics for the dynamic variant of the optimization problem (13′)-(14′) can also be interpreted as a feature that is already included in previously described formalization. In this case the moment Tₜ ε(Tₒ, Tₖ) of the transaction's finalization should be considered as an additional element of the contract space Ω₂, and the same is true for additional option premiums P(Tₜ) to be paid for the time difference (Tₜ−Tₒ), that becomes a very essential part of the problem Nevertheless, with the purpose to be as precise as possible, we will also give the special detailed variant of (13′)-(14′) for that case as follows

{X_{ad1}, P(Tₜ), Tₜ}=Arg Max {Ub[X(T), P(T), T]}, ∀X(T)εΩs(T) [symbol] Ω(T), B[X(T)]≦B(T), T ε(Tₒ, Tₖ) (13″)

and

{X_{ad1}, P(Tₜ), Tₜ}=Arg{Ub[X(T), P(T), T]≧[Max Ub[X(T), P(T), T]−ΔUb(T)]}, ∀X(T)εΩs(T) [symbol] Ω(T), B[X(T)]>B(T), T ε(Tₒ, Tₖ). (14″)

Evidently, each and every of aforementioned theoretical results, connected with the buyer's utility function Ub, is possible to implicate to the seller's utility function Us as well. The only (but very essential) difference is connected with the space of the definition for the seller's utility function—this function can only be defined for all X₂εΩ₂, because parameter X₁ becomes constant for any particular seller.

As it was already emphasized in the described background of this invention, there is always a third (invisible but powerful) participant in each and every transaction. “The Market” is the name of this third participant, which defines the prevailing values of the contract parameters (including the most crucial of them—the price), which defines the degree of possible flexibility for all the participants and, finally, which defines the potential profitability of the transaction. Therefore, almost any efforts expended for market analysis and active usage of said analysis results are only capable of adding more value to the foundation of the successful transaction. The Internet is exactly the place where such efforts are extremely productive due to the availability of practically unlimited data resources. The main part of the mathematical apparatus and tools to be used here are derived from the theory of statistical hypotheses as it is described, for example, by E. L. Lehmann in “resting Statistical Hypotheses”, Springer Verlag, 1997, the disclosure of which is incorporated herein by reference.

There are three different directions where the mathematical (statistical) models of the market should be predominately used. The first one is connected with the formation of the model of the actual market situation and tendencies with the goal to correct the buyer's preferences (the model of marginal market evaluations—position 24 in FIG. 2A)—the buyer's utility function should be realistic and should correspond with buyer's available resources.

The second direction presumes the statistical analysis of the items, which have been found preliminary admissible from the point of view of the buyer's utility function, and which are in contradiction with the actual market situation and tendencies (the model of the fair (prevailing) market contract terms). The trivial rational recommendation, in this case, is to delete from the procedure all items which are too good or too bad—situated in the large distances from the majority of the other items in the spaces of the item and/or contract parameters. The exact opposite idea is connected with the process of the “bargain” search—specifically aiming at the items which are far away from the majority of the others but only in a positive sense for the buyer.

Finally, the third direction is connected with the elaboration of the “fair” proposals which may constitute the basis of the possible compromise for the participants of a negotiation (the model of the asking and selling contract terms).

It makes sense in the context of this invention, to use a specific statistical apparatus for each of the aforementioned models. However, the database for all of these various operations is the same—the available or expertly estimated statistical information about all items situated in the proximity of the market domain in question.

The concept of the proximity, in this case, is not so simple and should be discussed in far more detail. It is evident that such market domain should include at least the search domain defined in equation (11) and the negotiation domains similarly defined thereafter for each pair of buyer/seller. However, it is almost equally evident that such limited definition of the market domain will not permit the formatting of the sufficiently sizeable statistical database and to draw the confident conclusions on its basis. The alternative approach includes the definition of admissible variation ΔX for each parameter X, ∀XεΩ, and description of the admissible market domain Ωm as follows

Ωm=∪{∀Y, X−ΔX≦Y≦X+ΔX, ∀XεΩ}. (16)

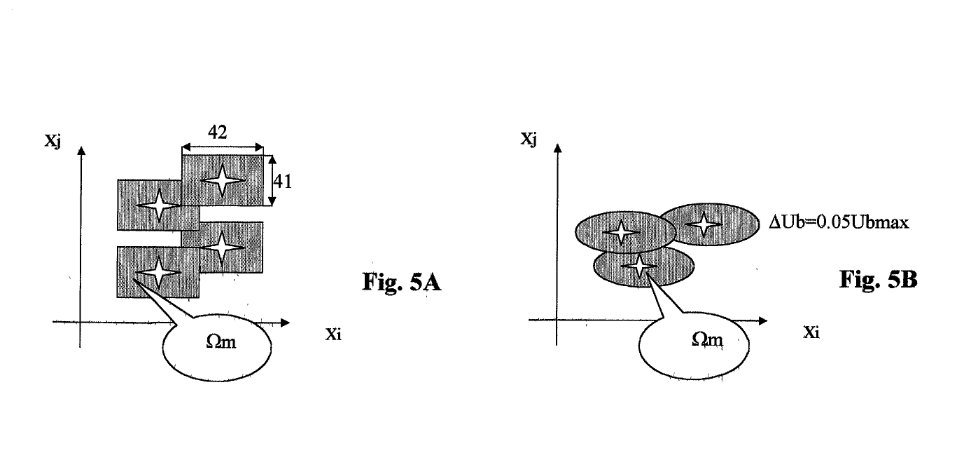

Definition (16) guarantees that each item of the market domain Ωm will not be distanced more than ΔX from at least one item with the parameter X, ∀XεΩ. This case is illustrated in FIG. 5A, where four items in question are designated by stars—40 designate ΔXi, 41 designate ΔXj and space Ωm is shaded.

The other possible metrics and definition of the space Ωm can be simultaneously generated by the buyer's utility function Ub(X) when its admissible variation is limited by the value ΔUb:

Ωm=∪{∀Y, Ub(X)−ΔUb≦Ub(Y)≦Ub(X)+ΔUb, ∀XεΩ}. (16′)

Definition (16′) guarantees that each item within the market domain Ωm will not differ in utility more than Δub in comparison with any item X, ∀XεΩ. This case is illustrated in FIG. 5B, where three items in question are designated by stars, the indifference curves with a constant 5% difference in utility (ΔUb=0.05 Ubmax) are shown and space Ωm is shaded.

The comparison of FIG. 5A and FIG. 5B illustrates that the difference in the definitions (16) and (16′) may essentially change the structure of the space Ωm.

In both cases we will define the space Ω as the space of the item's and contract's parameters in question—the search domain for the aforementioned first and second directions and the negotiation domain for the third direction.

In particular, to analyze the asking and selling contract terms in the small proximity near the items of said first list the description of the admissible market domain Ωm should be:

Ωm=∪{∀Y, X_{ad1}−ΔX≦Y≦X_{ad1}+ΔX, ∀X_{ad1}εΩ}

or

Ωm=∪{∀Y, Ub(X_{ad1})−ΔUb≦Ub(Y)≦Ub(X_{ad1})+ΔUb, ∀X_{ad1}εΩ},

where X_{ad1} stands for the parameters of the item included at the first list.

It is evident that the growth of the values ΔX and ΔUb will result in the growth of the database's size (which is good for its statistical confidence), however will simultaneously result in a loss of its characterization possibilities, because more items will be situated in larger distances from the items XεΩ. The possible solution may be found on the basis of the presumed permanent confidence level γ (usually, 0.9 or 0.95) and of minimization ΔX (or ΔUb) thereafter with the goal to stay in a small proximity from the items XεΩ.

When the size of the space Ωm to be tested is defined, it becomes possible through the Internet with all publicly available databases to obtain the information about all items YεΩm. Special attention should be paid to the degree of integrity of this information, especially when the information about the same item is coming from different sources (databases):

is it definitely true that we really have information about the same item and about the same parameter of the item or of the contract? (The terminology may be very different);

is the information actual? (How long ago was it revised?);

information about what parameters of item “k” is present and what is not? (for each of the databases);

are the values of the same parameters, that are coming from different sources, measured by the same system and by the same unit?

if there is a difference in values between the sources—which value should be considered true (the average one, the most recent or coming from most “reliable”, from your point of view, database)?

if there is any doubt about the integrity of the information in the aforementioned context—should it be immediately excluded (totally or in part) from the analysis—or should it be done on the basis of a special integrity statistical test?

This list of questions should be considered more as an example, rather than a serious analysis of the problems connected with the process of the initial data filtration—the theme is in some degree distant from the context of this invention. However, the quality of this preliminary filtration is capable of playing a crucial role in the successful finalization of the whole transaction.

The result of this preliminary data filtration is the matrix of the parameters' values, with the size m*n, where “m” is the number of the items in the space Ωm and “n” is the number of the parameters included in the vector Y. We should mention that not all of the positions of this matrix are always occupied—as for each iε(1,m) the information about each and every kε(1,n) is not available in the databases that have been searched. This matrix forms the informational basis for the elaboration of the statistical models of the market situation and tendencies.

The critical moment of any statistical procedure is the choice of the formal mathematical apparatus to be applied. The available possibilities are numerous. Just the naming of the main quality pairs for the parameters scalar-vector:

discrete-continuous

linear-nonlinear

static-dynamic

independent-correlated

already gives us (2)↑5=32 variants of possible model structures to be considered, without any emphasis paid to the degree of complexity and to the potential usefulness, that may deliver either one of the variants of the formal description inside the fixed model structure. Our position is not going to become easier after the recognition, that all of the aforementioned qualities should be present in some form in one market model or in the other.

The only practical recommendation that can be suggested in such a case is to use the simplest possible variant of the model, with the complexity that is just enough to satisfy the model's main need. If the result of the simulation is not accurate—then it is necessary to do the next step in the direction of the model's complexity.

Nevertheless, even in this case the results achieved by the simplest model should be useful as a starting point for the simulation with the more complicated model. That is the reason why it makes sense to generate the hierarchy of the models where each subsequent model is more complicated and more accurate than the previous one.

Any statistical model, as a rule, tends to use the same original characteristics of the parameters—frequency function for discrete variables or probability density function f(Y) for continuous ones. In a case when the size “m” of the parameters' matrix is not sufficient to obtain the confident expression for these functions the same results (but with a lesser degree of exactness) may be achieved through the usage of numerical characteristics—mathematical expectation MY) and dispersion D(Y).

The simplest linear regression model of marginal market evaluations may be constructed by converting the parameters' matrix through the algorithms of the regression analysis (the main theory is described, for example, by Norman R Draper, Harry Smith in “Applied Regression Analysis”, John Wiley & Sons, 1998, the disclosure of which is incorporated herein by reference) as follows

\overline{Y}ᵢ=ΣαᵢₖYₖ, i,k ε(1,n), (17)

where

\overline{Y}ᵢ stands for the computed value of the parameter Yᵢ;

Yₖ stands for the actual value of the parameter Yₖ;

αᵢₖ stands for the coefficient of linear regression for the pair of parameters (Yᵢ,Yₖ).

The algorithm is also delivering the information about statistical errors in the values of αᵢₖ and also in the final values of \overline{Y}ᵢ.

The system of “n” equations (17) in fact represents the simplest statistical model of the item Y and may be used for several very essential purposes. With its help we can fill the information gaps in the parameters' matrix just by writing down the computed values of the parameters in the places where the actual values are absent. This way, the statistical confidence of our database will not become any better, but the analysis of its content will become easier. In particular, for the component Ps ε Y, which is in fact the selling price of the item we have

\overline{P}s=ΣαₚₖYₖ, k ε(1,n), (18)

where αₚₖ are the marginal prices for each of the parameters Yₖ, k ε(1,n).

The knowledge of the vector {αₚₖ}, k ε(1, n), is very useful for the buyer and may usually change the buyer's utility function, in such a cardinal way, that we find it necessary to introduce the special recurrent loop in the algorithm of the invention (the positions 35, 37-38 in FIG. 2A), that makes the connected changes possible. Only knowing {αₚₖ}, k ε(1,n), and similar analogical regression vectors of marginal coefficients for other values of the contract terms the buyer may realize the actual significance of his preferences in light of the market realities.

In principle, the model of the fair (prevailing) market contract terms could be also constructed on the basis of the simple linear regression (17). However, we are going to draw the conclusions about fairness of the available proposals, and more, to delete unfair proposals from the procedure. This is the reason why more complicated (not using the hypothesis of linearity) model should be used here. Such formalism, that tests the fact: is this particular item the part of this particular statistical set (statistically belongs to it) or not, is well known from the theory of statistics (see Lehmann, reference cited).

There are two possible ways to provide this test. The first one should be used if the size of the statistical set in question is rather small and contains no more than 10-20 items. In that case the evaluations of the statistical expectation \overline{M}(Yᵢ) and of the statistical dispersion \overline{D}(Yᵢ) for the parameter Yᵢ of the parameter's matrix should be implemented in accordance with the formulae

\overline{M}(Yᵢ)={ΣYᵢₖ/m, k ε(1,m),

\overline{D}(Yᵢ)={Σ[Yᵢₖ−\overline{M}(Yᵢ)]↑2}/(m−1), k ε(1,m). (19)

After that the value Xᵢ(the parameter “i” of the item X to be checked, i.e. the asking price) and also the values \overline{M}(Yᵢ), \overline{D}(Yᵢ) from (19) are used as the entries into the special testing tables (see, for example, D. V. Lindley, W. F. Scott. “New Cambridge Statistical Tables”, Cambridge Univ. Press, 1995, the disclosure of which is incorporated herein by reference).

The result of the test should then be formulated as follows: using the level of confidence γ does or does not the element Xᵢ belong to the statistical set with the numerical characteristics \overline{M}(Yᵢ), \overline{D}(Yᵢ)?

That is exactly the answer to the question: does the value Xᵢ contradict the hypothesis of the fair contract's parameter or does it not?

The second method of providing this test should be used when the size of the statistical set in question is large enough to obtain the confidential evaluation for the probability density function \overline{f}(Y). In this case the first step could be to check the hypothesis with reference to the type of this function (normal exponential etc).

The knowledge of this exact type of function is very useful to draw further conclusions of its confidence and exactness. Subsequently, the evaluations of the statistical expectation \overline{M}(Yᵢ) and of the statistical dispersion \overline{D}(Yᵢ) for the parameter Yᵢ should be implemented in accordance with the formulae

\overline{M}(Yᵢ)=∫Yᵢ \overline{f}(Yᵢ)dYᵢ,

\overline{D}(Yᵢ))=∫{[Yᵢ−\overline{M}(Yᵢ)]↑2} \overline{f}(Yᵢ)dYᵢ. (20)

From this point the procedure is similar to the aforementioned one. The contradictions found at its conclusion (if any) should be divided in two groups. The items from the first one (where the difference in parameters is negative for the buyer) should be deleted from all considerations that follow. Quite the opposite, the items from the second group (where the difference in parameters is positive for the buyer) should be analyzed, much more carefully, as a possible candidate for a “bargain”.

The third and last model, based on the statistical analysis of the parameters' matrix, is the model of the prevailing asking and selling values for the contract terms to be used in the negotiation phase of the whole procedure. In fact the first component of this model, the model of the prevailing asking values for the contract terms, has already been analyzed in the previous step. This model describes the data for all items that are still active in the market (were not sold yet) together with contract term evaluations (i.e., similar to (17)). The same type of model, but one that describes the data for the items that have already been sold, in more or less short interval of the past, solely represents the model of the prevailing selling values for the contract terms. The gap between the values of the asking Ya(X) and the selling Ys(X) contract terms defines the possible field of the potential sellers' flexibility

Ya(X)−Ys(X)=ΔY(X) (21)

To describe this gap quantitatively we should generate both types of the values (asking and selling) for the same items. That again, can be done numerically, if the vector {αⱼₖ}, j,k ε(1,n), in (17) has already been defined for both asking and selling variants of the contract parameters.

On this basis the structure of the search domain Ωs is defined more exactly as follows

Ωs=Ωs′∪{Ωs″, jε(1,m)}, (22)

Ωsj″=∀X₂ⱼεΩ₂j, Yaj(X₂ⱼ)−Ysj(X₂ⱼ)≧0. ∃ X₂ⱼεΩs′, jε(1,m)}. (23)

where

Ωs′ stands for the space defined by equation (11) with Rs(X)=0;

Ωsj″ stands for the space of possible search defined by gap (19) for each seller #j, jε(1,m);

The more explicit definition (22)-(23) of the space (13) is one of the reasons for the recurrent return from step 22 to step 18 of the algorithm in FIG. 2A The other reason (the change of the buyer's preferences as a result of the evaluation of marginal prices) has already been discussed earlier.

The simplest ideas of a “fair” compromise are usually connected with some form of splitting the gap. For example, if Pa(X), Po(X) and Ps(X) represent the asking, the offering and the selling price of item X, we could expect, that at the compromise point

Ps(X)={Pa(X)+Po(X)}/2, (24)

and therefore the “fair” offering price should be defined by the equation

Po(X)=2 Ps(X)−Pa(X). (25)

It is necessary to mention here that we should use in (25) \overline{P}s(X) from the model (18) instead of the unknown a-priori Ps(X).

Returning again to the idea that all preferences should be measured in the utility units rather, than simply in money, we can conclude that all the compromises should also be measured in the utility units.

Therefore, we can rewrite (24) in its utility form

U[Ps(X)]={U[Pa(X)]+U[Po(X)]}/2, (26)

and

Po(X)=Arg{2 U[\overline{P}s(X)]−U[Pa(X)]}, Z=Arg φ(Z). (27)

The only problem with equation (27) is—which of the two utility functions (buyer's Ub(X) or seller's Us(X)) should be used here? The results will most likely differ, so the only rational recommendation, is again, to split the difference as follows

Po(X)={Pob(X)+Pos(X)}/2={Arg₁{2 Ub[\overline{P}s(X)]−Ub[Pa(X)]}+Arg₂{2 Us[Ps(X)]−Us[Pa(X)]}}/2. (28)

Here Arg₁, Arg₂ stands for the functions, which are opposite to Ub,Us consecutively:

Arg₁{Ub(Z)}≡Z, Arg₂{Us(Z)}≡Z

We have the possibility to simplify the dynamic variants of the equations (16)-(28)—where all the spaces and all the parameters should be treated as functions of time Tε(Tₒ,Tₖ)—presuming again that the moment Tₜ ε(Tₒ,Tₖ) of the transaction's finalization should be considered as an additional element of the contract space Ω₂, and the same becomes true for the additional option premiums P(Tₜ) to be paid for the time difference (Tₜ−Tₒ). In this case all of the aforementioned results are also valid for the dynamic variants of the models (16)-(28)—but the formal apparatus to be used (dynamic regression models, time series etc.) is much more complicated—it is described, for example, by Andy Pole, Mike West in “Applied Bayesian Forecasting and Times Series Analysis”, CRC Press, 1994, the disclosure of which is incorporated herein by reference.

It is certainly logical enough to start the detailed discussion of the negotiation segment of the procedure from the definition of the admissible negotiation domain Ωn—that is similar to the search Ωs and the market analysis Ωm domains, defined earlier. It is evident, that Ωn [symbol] χ₂. The goal of the negotiation is to find some point X₂εΩn, where both participants (the buyer and the seller) would obtain the result, which in some sense will be good enough for both of them to approve the closing of the transaction.

We will see that the term “in some sense” may have at least several very different realizations, starting from common sense (like splitting the difference in (24)-(27)), and finishing with some sophisticated concepts of the game theory as described, for example, by H. Peyton Young (Editor) in “Negotiation Analysis”, Ann Arbor, 1994, 204p.p., the disclosure of which is incorporated herein by reference.

As previously stated, we are going to describe the results in the terms of the buyer's Ub(X₂) and of the seller's Us(X₂) utility functions for the each pair of buyer/seller #j, jε(1,m). The “best” imaginary points X_{boj} for the buyer and Xₐₒⱼ for the seller may be found as follows

X_{boi}=Arg Max Ub(X), ∀XεΩ₂,

Xₐₒⱼ=Arg Max Us(X), ∀XεΩ₂,

Arg φ(Z)≡Z. (29)

and should be considered as the central points of the domains Ωnbj (for the buyer) and Ωnsj (for the seller), the locations where both parties are prepared to negotiate.

We have already seen how the flexibility of the buyer Fb(X) defines the radius of the search domain (FIG. 4B). Radiuses of the buyer's Rnbj(X₂) and seller's Rnsj(X₂) negotiation domains for the each pair of buyer/seller #j, jε(1,m), should be defined similarly as follows

Rnbj(X₂)=ΔUbj/Fb(X₂), ∀X₂εΩ₂,

Rnsj(X₂)=ΔUsj/Fsj(X₂), ∀X₂εΩ₂, jε(1,m). (30)

It is appropriate to mention here that the coordinates X_{boj} and the radiuses Rnbj(X₂) will have different values for the different numbers j, jε(1,m),—because, for each such special case, the values X₁ⱼ (the description of the item in question) will also be different.

Finally, combining (29) and (30) we define Ωnj for the pair of buyer/seller #j, jε(1,m), as follows

Ωnj=Ωnbj∩Ωnsj,

Ωnbj={∀X₂εΩ₂, [X_{boj}−Rnbj(X₂)]≦X₂≦[X_{boj}+Rnbj(X₂)]},

Ωnsj={∀X₂εΩ₂, [Xₐₒⱼ−Rnsj(X₂)]≦X₂≦[Xₐₒⱼ+Rnsj(X₂)]}, jε(1,m). (31)

The main theoretical tool for analyzing negotiations is the game theory, which applies to any situation in where the outcome of one person's actions or decisions depends, in a definite way, on the actions or decisions of others. In this sense, every negotiation is a game.

At this point we have all the elements of the game theory model presented:

two players (the buyer and the seller) who can make various agreements X₂ (outcomes) derived from the space of outcomes Ωn;

each player is presumed to be able to evaluate the attractiveness of every conceivable outcome, including the possibility of no agreement, with their criteria Ub(X₂) and Us(X₂) defined in the space of outcomes Ωn;

the description (31) of all outcomes X₂εΩn, which are in principle available for their choice;

the rules of the negotiation game, that presume the zero results for both buyer and seller if they will be enable to find a compromise in the form of X₂εΩn (so called BATNA [see H. Peyton Young, Reference cited pp.131-136]—Best Alternative To a Negotiated Agreement).

It is now, that some theoretical concepts of the game theory may become very useful. It seems reasonable to assume that no party will accept an agreement that leaves this party in a worse position than its BATNA. This assumption is known as individual rationality.

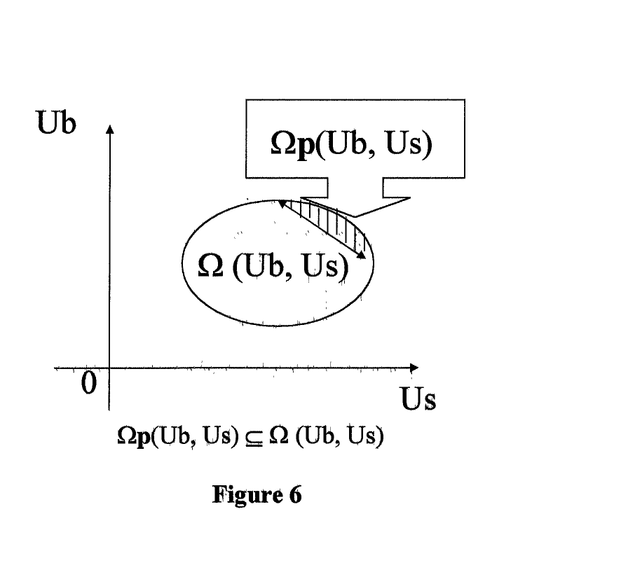

Therefore, the utility of each party's BATNA places a lower bound on the utility that each party must realize from the negotiated settlement. These minimum payoffs define the disagreement point—point (0,0) in FIG. 6. We are not yet considering here the possibility to find another transaction (for the buyer—to search for another item for the seller—to wait for another buyer). The lined region to the northeast of (0,0) delineates the agreements that are individually rational for both parties.

A second reasonable criterion of a negotiated agreement is that all potential gains should be realized. In other words, it should not be possible to make some parties better off while making the other party worse off Therefore, an agreement that satisfies this criterion is said to be efficient. The efficient agreements correspond to points that lie on the northeastern boundary of the negotiation set, which boundary is called the Pareto curve (after the Italian economist V. Pareto).

Any solution that is both individually rational and efficient (belongs to the Pareto curve) can be called reasonable; however there are typically many such solutions. Which of these solutions are most reasonable and may, therefore, be recommended as a basis for a buyer/seller compromise? We can offer several answers to this question.

First, the equal splitting of the differenceΔX₂ between the offering and the asking values of the parameter X₂ or the same equal splitting, but scaled in the utilities Ub(ΔX₂) and Us(ΔX₂)—as it is shown in (24)-(27).

Second, minimization of the maximum possible loss in the values of Ub(X₂) and Us(X₂) as a result of the choice Xo₂:

Xo₂=Arg Min Max {[Ub(X₂)−Ub(Xo₂)],[Us(X₂)−Us(Xo₂)]}, ∀X₂εΩp, (32)

where Ωp stands for the Pareto curve.

Third (The Nash Equilibrium), the result of the next optimization problem:

Xo₂=Arg Max {Ub(X₂)*Us(X₂), ∀X₂εΩp}. (33)

It is well known from the game theory—see, for example, Alvin E. Roth “Axiomatic Models of Bargaining”, Springer Verlag, 1979, the disclosure of which is incorporated herein by reference—that there always exists the unique solution for problem (33) possessing the following properties:

independence of the equivalent utility representations (measuring the temperature by Celsius or Fahrenheit does not change its actual value);

symmetry (the solution should not distinguish between the players if the model does not);

independence of irrelevant alternatives (this property allows the possibility to narrow the original negotiation space Ωn to a smaller space Ωp, without changing the outcome);

Pareto optimality.

To finalize the theme of dynamic specifics, we can rewrite equation (33) in its equivalent dynamic form as follows

{Xₒ₂, P(Tₜ), Tₜ}=Arg Max {Ub[X₂(T), P(T), T]*Us[X₂(T), P(T), T]}, ∀X₂(T)εΩp(T),Tε(Tₒ,Tₖ). (34)

All of the aforementioned considerations pertaining to the negotiation phase of the procedure to this point have been connected with the single pair of buyer/seller. What will be the difference if more than one item will be included in list #2? In that case the process of simultaneous interactive negotiations comprises of:

i) generating the Pareto curve for each pair of buyer/seller within the admissible negotiation domains for this pair;

ii) selecting the points of that curve which can constitute an admissible compromise for this pair on the basis of different optimality criteria;

iii) rating the results of the previous step in the order of the diminishing of the buyer's utility function thus generating the third list of items;

iv) under the buyer's instructions suggesting to the seller of the first item in the third list to agree on the variant in question or to suggest a concession;

v) rating and rewriting the third list again if necessary with respect to the concessions obtained from the sellers;

vi) recurrently repeating the two previous steps individually with the next seller from the third list until the first confirmation of agreement will be delivered or the third list will be unsuccessfully completed.

In the case, when at least one item is present in the third list, the system is organizing the process of due diligence and legal closing. The examples of these processes and its participants for real estate transaction are shown in Table 1 (Due Diligence) and Table 2 (Legal Closing).

TABLE 1
DUE DILIGENCE

| | | Agent for |
|---|---|---|
| Processes | Agent for the Buyer | the Seller |
| Title Search | A Title Company | — |
| Home Inspection | An Inspector | — |
| Mortgage Elaboration | A Mortgage Broker | — |
| Homeowner's Insurance | An Insurance Company | — |
| Tax Advice | An Accountant | An Accountant |
| Checking Financial | An Attorney | An Attorney |
| and Legal Issues | | |

TABLE 2
LEGAL CLOSING

| | Agent | |
|---|---|---|
| Processes | for the Buyer | Agent for the Seller |
| Preparation of | An Attorney | An Attorney |
| Documents | | |
| Key Transfer | The Buyer | The Selling Agent |

The whole procedure of this final step comprises of contacting the publicly available databases of necessary agents (title companies, house inspectors, mortgage and insurance brokers, accountants and attorneys), obtaining quotes from these agents for fulfilling their functions in conjunction with the item in question, choosing the best offer for each type of service and ordering these services after obtaining the buyer's approval for this step, using the professional agents' services online if necessary and possible, scheduling the closing real or virtual meeting of all agents and representatives and supplying this meeting with all legal and financial documentation to be signed and/or transferred.

Although the present invention has been disclosed in terms of a preferred embodiment, it will be understood that numerous variations and modifications could be made thereto without departing from the scope of the invention as set forth in the following claims. For example, the use of the Internet as a communication media is not unique—the whole procedure may also be ascertained through the usual phone lines etc.

What is claimed is:

1. A computer-based method for implementing a business transaction over the Internet that involves search, negotiation and legal closing using publicly available databases, information about participant's actual preferences and the statistical models of the market situation, comprising the steps of:
a) evaluating actual preferences of the potential customers (buyers) on the basis of interactive contacts with them over the Internet and defining the admissible search domain;
b) searching all said publicly available databases and generating the first list of admissible items inside of said search domain in accordance with said buyer's preferences having been formulated on the previous step;
c) in the case when said first list contains no items recurrent returning to step a) with the suggestion for said buyer to change said preferences with the goal to enlarge said admissible search domain and canceling all the next steps if said buyer disagrees with the suggested changes;
d) creating the statistical models of the market situation and tendencies at the proximity of said first list of items including the models of the marginal market evaluations and the models of the prevailing (asking and selling) market contract terms;
e) redefining the admissible search domain on the basis of the results obtained at the previous step and recurrent r to the step b) if necessary;
f) informing said buyer about the marginal prices of the items' parameters from said first list and about marginal prices of the contract parameters for the same items and recurrent returning to step a)-e) if said buyer considers to change preferences or confirming the already existing said first list of items if the buyer considers not to change preferences;
g) eliminating the items from said first list which are situated in contradiction with said statistical models of the market situation and tendencies (fair price hypothesis) thus generating the second shorter list of negotiable items;
h) in the case when said second list contains no items recurrent returning to step a) with the suggestion for said buyer to change said preferences with the goal to enlarge said search domain and canceling all the next steps if said buyer disagrees with the suggested changes;
i) evaluating actual preferences of the sellers of said second list of items on the basis of interactive contacts with them over the Internet and defining the admissible negotiation domains;
j) organizing the processes of simultaneous interactive negotiations at said negotiation domains between said buyer and each of said sellers from the said step i) on the basis of information derived at said steps a) ii) and formulating suggestions which can constitute the basis of a compromise for the each pair of buyer/seller;
k) generating the third list of the items for which the compromises between said buyer and any one of said sellers were agreed upon by both of them, designating the final item from said third list for which the result of said step j) is best for said buyer and obtaining said buyer's approval for finalizing the transaction;
l) in the case when said third list contains no items recurrent returning to the step a) with the suggestion for said buyer to change said preferences with the goal to enlarge said search domain and canceling all procedure if said buyer disagrees with the suggested changes;
m) generating all necessary legal documents and organizing the processes of due diligence and legal closing;
n) recurrent returning to the next item from said third list on said step k) if said step m) had been finished unsuccessfully and said process of due diligence had failed;
o) in the case when said third list contains no more items recurrent returning to step a) with the suggestion for said buyer to change said preferences with the goal to enlarge said search domain and canceling all procedure if said buyer disagrees with the suggested changes.

2. The computer-based method of claim 1, wherein said step of evaluating said actual preferences of said buyer further comprises generating approximate global utility function and its first derivatives named global flexibility functions in static or dynamic (time dependent) form in the space of the item's parameters and in the space of the negotiable contract's parameters.

3. The computer-based method of claim 2, wherein said step of generating said buyer's said approximate global utility functions is started by generating the approximate marginal utility functions by asking questions about equally preferable variants of parameters at the item's space and at the contract's space independently, then generating the global utility function in form of the direct superposition of the two independent marginal utility functions.

4. The computer-based method of claim 2, wherein said step of generating said buyer's said approximate multidimensional utility functions is accomplished in a one step process by asking questions about equally preferable variants of parameters at the item's space and at the contract's space simultaneously.

5. The computer-based method of claim 2, wherein said step of defining search domain Ωs comprises its description in accordance with formulae:
Ωs={∀XεΩ, [X₀−Rb(X)]≦X≦[X₀+Rb(X)]},
X₀=Arg Max Ub(X), ∀XεΩ,
Rb(X)=ΔUb/Fb(X)+Rs(X),
Fb(X)=dUb(X)/dX,
where
Ω=Ω₁∪Ω₂ stands for the space of definition for all item's and contract's parameters;
Rb(X) stands for admissible radius of the search domain along the axis X;
ΔUb stands for the admissible level of the utility loss for said buyer;
Rs(X) stands for an a-priori value of the similar admissible radius due to the potential seller's flexibility;
Fb(X) stands for said buyer's global flexibility function;
Ub(X) stands for said buyer's global utility function;
X=(X₁, X₂);
X₁ stands for the element of the space of the item's parameters Ω₁;
X₂ stands for the element of the negotiable contract parameters space Ω₂.

6. The computer-based method of claim 2, wherein said step of generating said first list of admissible items is accomplished by the unconstrained said utility function maximization in the spaces of the item and contract parameters and each of the items with parameters X_{ad1} to be included at the list should be defined by the formula
X_{ad1}=Arg {Ub(X)≧[Max Ub(X)−ΔUb]}, ∀XεΩs [symbol] Ω.
where Arg φ(Z)≡Z.

7. The computer-based method of claim 2, wherein said step of generating said first list of admissible items further comprises:
ascertaining said buyer's budget B(X) affordability limitations in static or dynamic form, solving the problem of constrained said utility function maximization under said buyer's said budget affordability limitations in the spaces of the item's and contract's parameters so as each of the items with parameters X_{ad1} to be included at the list should be defined by the formula
X_{ad1}=Arg {Ub(X)≧[Max Ub(X)−ΔUb]}, ∀XεΩs [symbol] Ω. B(X)≦Ba,
where Ba stands for the available funds and Arg φ(Z)≡Z.

8. The computer-based method of claim 1, wherein said step of creating statistical models of the market situation and tendencies further comprises:
analyzing asking and selling contract terms in small proximity near the items of said first list all over said publicly available databases;
generating the models of asking and selling contract terms for the items of the said first list in static or dynamic form;
generating the models of possible offering prices for negotiations with sellers in static or dynamic form.

9. The computer-based method of claim 8, wherein said step of analyzing asking and selling contract terms in small proximity near the items of said first list all over said publicly available databases further comprises:
the description of the admissible market domain Ωm as follows
Ωm=∪{∀Y, X_{ad1}−ΔX≦Y≦X_{ad1}+ΔX, ∀X_{ad1}εΩ}
or
Ωm=∪{∀Y, Ub(X_{ad1})−ΔUb≦Ub(Y)≦Ub(X_{ad1})+ΔUb, ∀X_{ad1}εΩ},
where
Y stands for the admissible point of statistics;
X_{ad1} stands for the parameters of the item included at the first list,
ΔX stands for the admissible maximum distance from the item with parameter X, ∀XεΩ;
Ub(*) stands for the said buyer's global utility function;
ΔUb stands for the admissible maximum loss in the said buver's global utility function.

10. The computer-based method of claim 8, wherein said step of generating said models of asking and selling contract terms for the items of said first list further comprises generating the hierarchy of the models:
i) linear regression models of the marginal market evaluations;
ii) nonlinear models of prevailing market contract terms for fair price hypothesis checking.

11. The computer-based method of claims 8, wherein said step of additionally redefining the admissible search domain Ωs comprises its description in accordance with formulae:
Ωs=Ωs′∪{Ωsj″, jε(1,m)},
Ωs′={∀XεΩ, [X₀−Rb(X)]≦X≦[X₀+Rb(X)]},
X₀=Arg Max Ub(X), ∀XεΩ,
Arg φ(Z)≡Z,
Rb(X)=ΔUb/Fb(X),
Fb(X)=dUb(X)/dX,
Ωsj″={∀X₂ⱼεΩ₂j, Yaj(X₂ⱼ)−Ysj(X₂ⱼ)≧0, ∃X₂ⱼεΩs′, jε(1,m)},
where
Ω=Ω₁∪Ω₂ stands for the space of definition for all item's and contract's parameters;
Rb(X) stands for admissible radius of the search domain along the axis X;
ΔUb stands for the admissible level of the utility loss for said buyer;
Fb(X) stands for said buyer's global flexibility function;
Ub(X) stands for said buyer's global utility function;
X=(X₁, X₂);
X₁ stands for the element of the space of the item's parameters Ω₁;
X₂ stands for the element of the negotiable contract parameters space Ω₂;
Yaj(X₂ⱼ) stands for the asking values of the contract terms for the parameter X₂ⱼ for each seller #j, jε(1,m);
Ysj(X₂ⱼ) stands for the selling values of the contract terms for the parameter X₂ⱼ for each seller #j, jε(1,m).

12. The computer-based method of claim 8, wherein said step of additionally eliminating items from said first list further comprises:
i) excluding the items contradicting fair price hypothesis;
ii) informing said buyer about marginal prices of changing item's parameters;
iii) recurrently changing said first list on the basis of corrections of buyer's preferences with respect to the information from said step ii).

13. The computer-based method of claim 8, wherein said step of generating said models of possible offering prices Po(X) for negotiations further comprises generating the surface of offering prices for all items of negotiable space in accordance with formulae
Po(X)=2 Ps(X)−Pa(X)
or
Po(X)={Arg₁{2 Ub[\overline{P}s(X)]−Ub[Pa(X)]}+Arg₂{2 Us[\overline{P}s(X)]−Us[Pa(X)]}}/2
where
\overline{P}s(X) stands for the statistical evaluation for the selling price of the item X;
Pa(X) stands for the asking price of the item X;
Ub,Us stands for the buyer's and the seller's utility functions consecutively;
Arg₁, Arg₂ stands for the functions which are opposite to Ub, Us consecutively:
Arg₁{Ub(Z)}≡Z, Arg₂{Us(Z)}≡Z.

14. The computer-based method of claim 2, wherein said step of evaluating actual preferences of the sellers of said second list of the items in the same market domain on the basis of interactive contacts with them over the Internet further comprises generating their approximate multidimensional utility and flexibility functions in static or dynamic (time dependent) form in the space of the negotiable contract parameters for each of them.

15. The computer-based method of claims 14, wherein said step of defining the negotiation domain Ωnj for the each pair of buyer/seller #j, jε(1,m) comprises its description in accordance with the formulae:
Ωnj=Ωnbj∩Ωnsj,
Ωnbj={∀X₂εΩ₂, [X_{boj}−Rnbj(X₂)]≦X₂≦[X_{boj}+Rnbj(X)]},
Ωnsj={∀X₂εΩ₂, [Xₐₒⱼ−Rnsj(X₂)]≦X₂≦[Xₐₒⱼ+Rnsj(X₂)]}, jε(1,m).
X_{boj}=Arg Max Ub(X), ∀XεΩ₂,
Xₐₒⱼ=Arg Max Us(X), ∀XεΩ₂,
Arg φ(Z)≡Z,
Rnbj(X₂)=ΔUbj/Fb(X₂), Fb(X₂)=dUb(X₂)/dX₂,
Rnsj(X₂)=ΔUsj/Fsj(X₂), Fsj(X₂)=dUsj(X₂)/dX₂,
where
Rnbj(X₂) stands for the admissible radius of the negotiation domain due to the buyer's flexibility;
Rnsj(X₂) stands for the admissible radius of the negotiation domain due to the potential seller's flexibility;
ΔUbj stands for the admissible level of the utility loss for said buyer;
Fb(X₂) stands for the global buyer's flexibility function;
Ub(X₂) stands for the global buyer's utility function;
ΔUsj stands for the admissible level of the utility loss for said seller;
Fsj(X₂) stands for the global seller's flexibility function;
Usj(X₂) stands for the global seller's utility function;
X₂ stands for the element of the space Ω₂ of negotiable contract's parameters.

16. The computer-based method of claim 12, wherein said step of organizing the processes of simultaneous interactive negotiations further comprises:
i) generating the Pareto curve for each pair of buyer/seller within the admissible negotiation domains for this pair;
ii) selecting the points of that curve which can constitute an admissible compromise for this pair on the basis of different optimality criteria;
iii) rating the results of the previous step in the descending order of the buyer's utility function thus generating the third list of items;
iv) under the buyer's instructions suggesting to the seller of the first item in the third list to agree on the variant in question or to suggest a concession;
v) rating and rewriting the third list again if necessary with respect to the concessions obtained from the sellers;
vi) recurrently repeating the two previous steps individually with the next seller from the third list until the first confirmation of agreement will be delivered or the third list will be unsuccessfully completed.

17. The computer-based method of claim 16, wherein said step of selecting the points of said Pareto curve, that can constitute the admissible compromise for participants, further comprises designating the points of said Pareto curve that minimize the maximal possible loss in said utility functions for any of them.

18. The computer-based method of claim 16, wherein said step of selecting the points of said Pareto curve, that can constitute the admissible compromise for participants, further comprises designating the unique point of said Pareto curve that is the result of the next optimization problem (the Nash equilibrium):
X₂ₒₚₜ=Arg Max {Ub(X₂ₚ)*Us(X₂ₚ)},
where
X₂ₒₚₜ stands for the compromise in the space of negotiable contract terms;
Ub(X₂ₚ) stands for the buyer's utility function value at the Pareto curve points X₂ₚ;
Us(X₂ₚ) stands for the seller's utility function value at the same points.

19. The computer-based method of claim 16, wherein said step of generating the Pareto curve of negotiable space for each pair of buyer/seller her comprises the simultaneous choice of the timing strategy Xₒ₂(Tₜ), Tₜε(Tₒ,Tₖ), for the transaction with possibilities of additional payments P(Tₜ) for time dependent options on the basis of said dynamic forms U[X₂(T), P(T), T] for said utility functions and said price models in accordance with the formula:
{Xₒ₂(Tₜ), P(Tₜ), Tₜ}=Arg Max {Ub[X₂ (T), P(T), T]*Us[X₂ (T), P(T), T]}, ∀X₂(T)εΩp(T),Tε(Tₒ,Tₖ).

20. The computer-based method of claim 1, wherein said step of organizing the processes of the due diligence and of the legal closing further comprises contacting said publicly available databases of necessary agents (title companies, house inspectors, mortgage and insurance brokers, accountants and attorneys), obtaining quotes from these agents for fulfilling their functions in conjunction with the item in question, choosing the best offer for each type of service and ordering these services after obtaining said buyer's approval for this step, using the professional agents' services online if necessary and possible, scheduling the closing real or virtual meeting of all agents and representatives and supplying this meeting with all legal and financial documentation to be signed and/or transferred.

21. A computer-based system for implementing a business transaction over the Internet, that involves search, negotiation and legal closing using publicly available databases, information about participant's actual preferences and the statistical models of the market situation, said system comprising:
a potential buyer's computer terminal with its communication means;
a plurality of said publicly available databases hosted over the Internet with its communication means;
a plurality of potential sellers' computer terminals with its communication means;
a plurality of due diligence agents' computer terminals with its communication means;
a central operating block with its communication means, said central operating block comprising:
i) a utility evaluation unit, that is having possibilities through said communication means of said central operating block to contact interactively said potential buyer's computer terminal, said plurality of potential sellers' computer terminals, and is programmed for evaluating actual preferences of said potential buyer, the plurality of preferences for said plurality of potential sellers and also the admissible search and negotiation domains;
ii) a search unit, that is coupled to said utility evaluation unit, and is having possibilities through said communication means of said central operating block to contact interactively said plurality of publicly available databases hosted over the Internet, and is programmed for searching said databases and for generating the first list of admissible items in accordance with said actual preferences of said potential buyer;
iii) a market analysis unit, that is coupled with said search unit, and having possibilities through said communication means of said central operating block to contact interactively said plurality of publicly available databases hosted over the Internet, and is programmed for creating the statistical model of the market situation and tendencies at the market domain at the proximity of the first list of items, for redefining the admissible search domain and recurrent return to the search of the admissible items, if necessary, and for eliminating items from the first list, which are situated in contradiction with main market tendencies, thus generating the second shorter list of negotiable items;
iv) a negotiation unit, that is coupled with said market analysis unit, and is having possibilities through said communication means of said central operating block to contact interactively said potential buyer's computer terminal and said plurality of potential sellers' computer terminals, and is programmed for organizing the processes of simultaneous interactive negotiations between said buyer and each of said sellers of the items of said second list at said negotiation domains, for formulating suggestions which can constitute the basis of a compromise, for generating the third list of the items, for which a compromise between said buyer and said seller were agreed upon by both of them, for designating the final item from said third list, for which the result of negotiations is best for said buyer, and for obtaining said buyer's approval for finalizing the transaction;
v) a due diligence unit, that is coupled with said negotiation unit, and is having possibilities through said communication means of said central operating block to contact interactively said plurality of due diligence agents' computer terminals, and is programmed for generating all necessary legal documents and for organizing the processes of due diligence and legal closing through interactive connections between said buyer, said seller of said final item and said plurality of due diligence agents;
vi) a first correction unit, that is coupled with said search unit, and is having possibilities through said communication means of said central operating block to contact interactively said potential buyer's computer terminal and is programmed for suggesting to change said buyer's preferences with the goal to enlarge said admissible radius of the search domain in the case, when said first list contains no items, and for canceling all the next steps if said buyer disagrees with suggested changes;
vii) a second correction unit, that is coupled with said market analysis unit, and is having possibilities through said communication means of said central operating block to contact interactively said potential buyer's computer terminal, and is programmed for informing said buyer about marginal prices of the items' parameters from said first list and about marginal prices of the contract parameters of the items from said first list, and for suggesting to change said buyer's preferences with the goal to enlarge said admissible radius of the search domain, and for canceling all the next steps if said buyer disagrees with suggested changes;
viii) a third correction unit, that is coupled with said market analysis unit, and is programmed for suggesting to change said buyer's preferences with the goal to enlarge said admissible radius of the search domain in the case, when said second list contains no items, and for canceling all the next steps if said buyer disagrees with the suggested changes;
ix) a fourth correction unit, that is coupled with said negotiation unit, and is programmed for suggesting to change said buyer's preferences with the goal to enlarge said admissible radius of the search domain, if said negotiation unit functioned unsuccessfully and third list contains any items, and for canceling all the next steps if said buyer disagrees with the suggested changes;
x) a fifth correction unit, that is coupled with said due diligence unit, and is programmed for recurrent return to the next item from said third list, having been generated by said negotiation unit, if said due diligence unit functioned unsuccessfully and process of due diligence failed.

22. The system according to claim 21, wherein said utility evaluation unit is programmed for generating said buyer's approximate global utility functions and its first derivatives, named global flexibility functions, in static or dynamic (time dependent) form in the space of the item's parameters and in the space of the negotiable contract's parameters.

23. The system according to claim 22, wherein said utility evaluation unit is programmed for generating said buyer's approximate global utility functions starting by generating the approximate marginal utility functions by asking questions about equally preferable variants of parameters at the item's space and at the contract's space independently, then generating said global utility function in the form of the direct superposition of the two independent marginal utility functions.

24. The system according to claim 22, wherein said utility evaluation unit is programmed for generating said buyer's approximate global utility functions in a one step process by asking questions about equally preferable variants of parameters at the item's space and at the contract's space simultaneously.

25. The system according to claim 22, wherein said utility evaluation unit is programmed for defining search domain Ωs in accordance with formulae:
Ωs={∀XεΩ, [X₀−Rb(X)]≦X≦[X₀+Rb(X)]},
X₀=Arg Max Ub(X), ∀XεΩ,
Rb(X)=ΔUb/Fb(X)+Rs(X),
Fb(X)=dUb(X)/dX,
where
Ω=Ω₁∪Ω₂ stands for the space of definition for all item's and contract's parameters;
Rb(X) stands for admissible radius of the search domain along the axis X;
ΔUb stands for the admissible level of the utility loss for said buyer;
Rs(X) stands for an a-priori value of the similar admissible radius due to the potential seller's flexibility;
Fb(X) stands for said buyer's global flexibility function;
Ub(X) stands for said buyer's global utility function;
X=(X₁, X₂);
X₁ stands for the element of the space of the item's parameters Ω₁;
X₂ stands for the element of the negotiable contract parameters space Ω₂.

26. The system according to claim 22, wherein said search unit is programmed for generating said first list of admissible items by accomplishing the unconstrained said buyer's utility function maximization in the spaces of the item's and contract's parameters and each of the items with parameters X_{ad1} to be included at the list should be defined by the formula
X_{ad1}=Arg {Ub(X)≧[Max Ub(X)−ΔUb]}, ∀XεΩs [symbol] Ω,
where Arg φ(Z)≡Z.

27. The system according to claim 22, wherein said search unit is programmed for generating said first list of admissible items by accomplishing the next steps:
i) obtaining the buyer's budget affordability limitations in static or dynamic form;
ii) solving the problem of constrained utility function maximization under the buyer's budget limitations in the spaces of the item and contract parameters so as each of the items with parameters X_{ad1} to be included at the list should be defined by the formula
X_{ad1}=Arg {Ub(X)≧[Max Ub(X)−ΔUb]}, ∀XεΩs [symbol] Ω, B(X)≦Ba,
where Ba stands for the available funds and Arg φ(Z)≡Z.

28. The system according to claim 22, wherein said market analysis unit is programmed for creating said the statistical models of the market situation and tendencies through the next steps:
i) analyzing asking and selling prices of the items in small proximity near the items of the first list all over the publicly available databases;
ii) generating the models of asking and selling fair prices for the items of the first list in static or dynamic form;
iii) generating the models of possible offering prices for negotiations with sellers in static or dynamic form.

29. The system according to claim 28, wherein said market analysis unit is programmed for analyzing asking and selling prices of the items in small proximity near the items of the first list all over the publicly available databases and for the description of the admissible market domain Ωm as follows
Ωm=∪{∀Y, X−ΔX≦Y≦X+ΔX, ∀XεΩ}
or
Ωm={∀Y, Ub(X)−ΔUb≦Ub(Y)≦Ub(X)+ΔUb, ∀XεΩ},
where
Y stands for the admissible point of statistics;
X stands for the parameter of any item inside the said search or inside the said negotiation domain Ω;
ΔX stands for the admissible maximum distance from the item with parameter X, ∀XεΩ;
Ub(*) stands for the said buyer's global utility function;
ΔUb stands for the admissible maximum loss in the said buyer's global utility function.

30. The system according to claim 28, wherein said market analysis unit is programmed for generating said models of asking and selling fair prices for the items of said first list by generating the hierarchy of fair price models:
i) linear models for obtaining marginal prices of item's parameters;
ii) nonlinear models for fair price hypothesis checking.

31. The system according to claim 28, wherein said market analysis unit is programmed for redefining the admissible search domain Ωs in accordance with formulae:
Ωs=Ωs′∪{Ωsj″, jε(1,m)},
Ωs′={∀XεΩ, [X₀−Rb(X)]≦X≦[X₀+Rb(X)]},
X₀=Arg Max Ub(X), ∀XεΩ,
Arg φ(Z)≡Z.
Rb(X)=ΔUb/Fb(X),
Fb(X)=dUb(X)/dX
Ωsj″={∀X₂ⱼεΩ₂j, Yaj(X₂ⱼ)−Ysj(X₂ⱼ)≧0, ∃X₂ⱼεΩs′, jε(1,m)},
where
Ω=Ω₁∪Ω₂ stands for the space of definition for all item's and contract's parameters;
Rb(X) stands for admissible radius of the search domain along the axis X;
ΔUb stands for the admissible level of the utility loss for said buyer;
Fb(X) stands for said buyer's global flexibility function;
Ub(X) stands for said buyer's global utility function;
X=(X₁, X₂);
X₁ stands for the element of the space of the item's parameters 1i;
X₂ stands for the element of the negotiable contract parameters space Q2;
Yaj(X₂ⱼ) stands for the asking values of the contract terms for the parameter X₂ⱼ for each seller #j, jε(1,m);
Ysj(X₂ⱼ) stands for the selling values of the contract terms for the parameter X₂ⱼ for each seller #j, jε(1,m).

32. The system according to claim 30, wherein said market analysis unit is programmed for additionally eliminating items from said first list by:
i) excluding the items contradicting fair price hypothesis;
ii) informing said buyer about marginal prices of changing item's parameters;
iii) recurrently changing said first list on the basis of corrections of buyer's preferences with respect to the information from said step ii).

33. The system according to claim 28, wherein said market analysis unit is programmed for generating said models of possible offering prices for negotiations with sellers by generating the surface of said offering prices for all items of negotiable space in accordance with formulae
Po(X)=2 \overline{P}s(X)−Pa(X)
or
Po(X)={Arg₁{2 Ub[\overline{P}s(X)]−Ub[Pa(X)]}+Arg₂{2 Us[\overline{P}s(X)]−Us[Pa(X)]}}/2
where
\overline{P}s(X) stands for the statistical evaluation for the selling price of the item X;
Pa(X) stands for the asking price of the item X;
Ub,Us stands for the buyer's and the seller's utility functions consecutively;
Arg₁, Arg₂ stands for the functions which are opposite to Ub, Us consecutively:
Arg₁{Ub(Z)}≡Z, Arg₂{Us(Z)}≡Z.

34. The system according to claim 21, wherein said utility evaluation unit is programmed for generating said sellers' approximate multidimensional utility and flexibility functions in static or dynamic (time dependent) form in the space of the negotiable contract parameters for each of them.

35. The system according to claim 34, wherein said utility evaluation unit is programmed for defining the negotiation domain Ωnj for the each pair of buyer/seller #j, jε(1,m), in accordance with the formulae:
Ωnj=Ωnbj∩Ωnsj,
Ωnbj={∀X₂εΩ₂, [X_{boj}−Rnbj(X₂)]≦X²≦[X_{boj}+Rnbj(X₂)]},
Ωnsj={∀X₂εΩ₂, [Xₐₒⱼ−Rnsj(X₂)]≦X₂≦[Xₐₒⱼ+Rnsj(X₂)]}, jε(1,m).
X_{boj}=Arg Max Ub(X), ∀XεΩ₂,
Xₐₒⱼ=Arg Max Us(X), ∀XεΩ₂,
Arg φ(Z)≡Z,
Rnbj(X₂)=ΔUbj/Fb(X₂), Fb(X₂)=dUb(X₂)/dX₂,
Rnsj(X₂)=ΔUsj/Fsj(X₂), Fsj(X₂)=dU(X₂)/dX₂,
where
Rnbj(X₂) stands for the admissible radius of the negotiation domain due to the buyer's flexibility;
Rnsj(X₂) stands for the admissible radius of the negotiation domain due to the potential seller's flexibility;
ΔUbj stands for the admissible level of the utility loss for said buyer;
Fb(X₂) stands for the global buyer's flexibility function;
Ub(X₂) stands for the global buyer's utility function;
ΔUsj stands for the admissible level of the utility loss for said seller;
Fsj(X₂) stands for the global seller's flexibility function;
Usj(X₂) stands for the global seller's utility function;
X₂ stands for the element of the space Ω₂ of negotiable contract parameters.

36. The system according to claim 28, wherein said negotiation unit is additionally programmed for:
i) generating the Pareto curve for each pair of buyer/seller within the admissible negotiation domains for this pair;
ii) selecting the points of that curve which can constitute an admissible compromise for this pair on the basis of different optimality criteria;
iii) rating the results of the previous step in the descending order of the buyer's utility function thus generating the third list of items;
iv) under the buyer's instructions suggesting to the seller of the first item in the third list to agree on the variant in question or to suggest a concession;
v) rating and rewriting the third list again if necessary with respect to the concessions obtained from the sellers;
vi) recurrently repeating the two previous steps individually with the next seller from the third list until the first confirmation of agreement will be delivered or the third list will be unsuccessfully completed.

37. The system according to claim 36, wherein said negotiation unit is additionally programmed for selecting the points of said Pareto bound by designating the points which minimizes the maximal possible loss in said utility function for any of them.

38. The system according to claim 36, wherein said negotiation unit is additionally programmed for selecting the only point of said Pareto bound which is the result of the next optimization problem (the Nash equilibrium):
X₂ₒₚₜ=Arg Max Ub(X₂ₚ)*Us(X₂ₚ),
where
X₂ₒₚₜ stands for the compromise in the space of negotiable contract terms;
Ub(X₂ₚ) stands for the buyer's utility function value at the Pareto curve points X₂ₚ;
Us(X₂ₚ) stands for the seller's utility function value at the same points.

39. The system according to claim 36, wherein said negotiation unit is additionally programmed for selecting the points of said Pareto bound with respect to the simultaneous choice of the timing strategy Xₒ₂(Tₜ), Tₜε(Tₒ,Tₖ), for the transaction with possibilities of additional payments P(Tₜ) for time dependent options on the basis of said dynamic forms U[X₂ (T), P(T), T] for said utility functions and said price models in accordance with the formula:
{Xₒ₂(Tₜ), P(Tₜ), Tₜ}=Arg Max {Ub[X₂(T), P(T), T]*Us[X₂(T), P(T), T]}, ∀X₂(T)εΩp(T),Tε(Tₒ,Tₖ).

40. The system according to claim 21, wherein said due diligence unit is additionally programmed for contacting said publicly available databases of necessary agents (title companies, house inspectors, mortgage and insurance brokers, accountants and attorneys), obtaining quotes from these agents for fulfilling their functions in conjunction with the item in question, choosing the best offer for each type of service and ordering these services after obtaining said buyer's approval for this step, using the professional agents' services online if necessary and possible, scheduling the closing, actual or virtual, meeting of all agents and representatives and supplying this meeting with all legal and financial documentation to be signed and/or transferred.
